(19) United States
(12) Patent Application Publication
(10) Pub. No.: US 2015/0134603 A1
(43) Pub. Date: May 14, 2015

(54) SYSTEMS, METHODS, AND COMPUTER PROGRAM PRODUCTS FOR CONTACT INFORMATION

(71) Applicants: ZACH MELAMED, San Francisco, CA (US); Ryan Allis, San Francisco, CA (US); Anima Sarah LaVoy, San Francisco, CA (US); Jared Weinstock, San Francisco, CA (US); Dan Ho, Redwood City, CA (US); Nick Gonzalez, Oakland, CA (US); Lilia Tamm, San Francisco, CA (US); Dana Chambers, San Francisco, CA (US)

(72) Inventors: ZACH MELAMED, San Francisco, CA (US); Ryan Allis, San Francisco, CA (US); Anima Sarah LaVoy, San Francisco, CA (US); Jared Weinstock, San Francisco, CA (US); Dan Ho, Redwood City, CA (US); Nick Gonzalez, Oakland, CA (US); Lilia Tamm, San Francisco, CA (US); Dana Chambers, San Francisco, CA (US)

(73) Assignee: Connect Software Corporation, San Francisco, CA (US)

(21) Appl. No.: 14/514,730

(22) Filed: Oct. 15, 2014

Related U.S. Application Data
(60) Provisional application No. 61/891,163, filed on Oct. 15, 2013.
(60) Provisional application No. 61/944,325, filed on Feb. 25, 2014.

(51) Int. Cl. G06F 17/30; G06F 11/14

(52) U.S. Cl. CPC G06F 17/30156; G06F 11/1453; G06F 17/30345
USPC 707/609; 707/692

(57) ABSTRACT

A computer based method and system for managing contact information from the contacts of a user. The contact information is collected and transformed to a consistent format, which permits resolution of conflicting information from multiple sources, such as differences in location information from different social mediums. This transformation enables cross media communication, such as notifications between users and contacts about location or other matters. In addition, the transformation permits a single communication to be transformed for use in multiple social media platforms, whether to a single contact or a select group. User interfaces are provided for display and use of such functional interactions.

### CROSS-REFERENCE TO RELATED APPLICATIONS

This application claims the benefit of U.S. Provisional Application No. 61/891,163, filed on Oct. 15, 2013 and U.S. Provisional Application No. 61/944,325, filed on Feb. 25, 2014, both of which are hereby incorporated in its entirety.

### STATEMENT REGARDING GOVERNMENT SUPPORT

Not Applicable.

### FIELD OF THE INVENTION

The present invention relates generally to management of contact information, including location-based notifications and, more particularly, to handling location data derived from more than one source.

### BACKGROUND

Increasingly, people are interacting with others via email, mobile phones and social networks. Typically for each, a person maintains a list of people and organizations with whom he/she wishes to communicate. For example, a user typically maintains an address book of contacts on each email service and/or on a mobile phone. In addition, a user of social networks typically maintains a list of contacts for each respective social network (e.g., Facebook, LinkedIn, Twitter, Foursquare, Instagram, Connect, Twitter, Google+, etc.). The format of contact data across each email service, mobile phone, and social network (each referred to generally herein as a “platform”) can vary widely.

Because email and mobile phone use has become ubiquitous, and because users may have accounts on multiple social networks or through multiple email service providers, users may have data in formats for each platform that often varies widely and makes it difficult to reconcile and standardize such data. In other words, each platform often varies widely in handling information that may be similar, but not identical. As a result, similar information in varying data formats can be unwieldy to manage or to convert from platform to platform. Furthermore, conventional address books may contain duplicate information for the same contact: e.g., phone numbers (home, mobile, work, etc.), email addresses (work, home, webmail, etc.), chat handles (Gtalk, AIM, BBM, Skype, etc.), mailing addresses, (micro) blogs and homepages (Twitter, Tumblr, etc.). With an increasing number of platforms available for connecting with people, coupled with an overlap of duplicate and/or inconsistent data, the format and standardization of such data can be a daunting task.

For instance, social media platforms such as LinkedIn, Facebook, Foursquare, and Instagram all have unique representations of location data. Even where the format is the same, the underlying data may not be identical, making standardization exceptionally difficult With unique formats, the problem is often compounded. As a specific example, if two people post (e.g., check-in) at “Dolores Park in San Francisco, Calif.” through two different platforms (e.g., Facebook and Foursquare), different geographic information may be generated from each platform. One platform may generate a string of latitudinal and longitudinal coordinates (e.g., 37.7583° N., 122.4275° W.), while another platform may generate the common English name of the place (e.g., Dolores Park, San Francisco, Calif., United States of America). Moreover, even where both platforms use the same format (e.g., both utilize latitudinal and longitudinal coordinates), the specific coordinates may be different, thus hampering the effort to normalize what would otherwise be considered the same place.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

The present system and method allow a user to manage notifications associated with a post by a user contact. More specifically, the present approach provides systems, methods and computer program products for handling location data derived from more than one source. Data from various sources, such as Facebook, LinkedIn, Google Contacts, mobile phone address books, Foursquare, Twitter, and/or Instagram, are collected and consolidated into a single record having a standardized format. Embodiments of the present invention enable the creation, generation and receipt of location-based notifications, enable the display of location information on a geographic map, and enable calling and SMS within the application.

One embodiment is a method in a computer system for managing contact information relating to contacts of a user. Such a method may involve a number of steps. One step may include collecting contact information over a communications network from a plurality of identified sources or platforms, where the contact information includes location information. Another step may be transforming the collected contact information into a standardized format and eliminating duplicated information within the contact information. Another step may include resolving conflicting information within the collected and formatted contact information, enabling the consolidating of the collected contact information for a contact into a contact data record, and storing each contact data record in a data repository. Such collecting, transforming, eliminating, resolving, consolidating, and storing may be performed on at least one computer processor. The collecting of contact information may be responsive to receiving a user request to aggregate the contact information of the user from the plurality of identified sources. Optionally, the contact information may include at least one contact generated notification with contact location information about the contact. While the standardized formatting of location information may depend on the application, such standard may be by latitude and longitude.

A variety of alternative embodiments are available. For example, the method may include storing a predefined notification parameter for use in filtering one or more contact notifications, receiving a location-based (contact originated) notification from at least one of the plurality of identified sources, wherein the contact notification includes location information about a contact, and transforming the location information of the contact notification into a standardized format, with the storing, receiving and transforming being performed on at least one computer processor. Such a predetermined notification parameter may be selected by a user using a user-interface device. The resolving of conflicting information within the contact information may be by assigning confidence factors to the conflicting information and selecting location information having a highest confidence factor, with such confidence factors determined empirically or dynamically, as provided herein.

Sonic embodiments may involve receiving a user notification for posting user information to at least one contact via at least one of the plurality of identified sources, converting the user notification into a source format, and then posting the user notification to the at least one contact, with such posting being via the at least one of the plurality of identified sources. The at least one contact may also be a user selected group of contacts. Such a user notification may include user location information about the user. In some cases, such a notification may include a length or duration of time for display associated with the location information. As detailed below, a user notification may also include a limited communication, such as a text or SMS message.

In some embodiments, it may be desirable to periodically determine if contact information has changed at one or more of the plurality of identified sources, and update the one or more respective contact data records to reflect contact information changes. These may be performed using the at least one computer processor. Optionally, updating one or more respective contact data records to reflect contact information changes can also include removing selected contact information from a data record, so as to comply with terms of service of a source for that contact information.

According to some embodiments, a method may include the at least one computer providing to the user-interface device a display of a geographic map and displaying at least one marker on the map, the marker representing a user's contact, and wherein each of the at least one markers indicates a location of a contact based on the location information of the contact. Optionally, the marker may include an image of the contact. The providing of the display of a geographic map, and displaying at least one marker on the map may be performed on at least one processor, with the display on the user-interface device for use by the user.

A contact record may include a home location field, a work location field, and a current location field, and determining from the collected contact information of a contact any home location information, work location information, and current location information, such that some methods may involve storing any home location information, work location information, and current location information within the respective fields in the respective contact record of the contact using the computer processor controlling the data repository.

Another embodiment is a method in a computer system for managing contact information relating to contacts of a user. The steps of the method may include collecting contact information over a communications network from identified sources, the contact information including location information, transforming the collected contact information into a standardized format, eliminating duplicate information, resolving conflicting information within the contact information, and consolidating the collected contact information for a contact into a contact data record. The contact data records may be stored a data repository. In addition, a predefined notification parameter for use in filtering one or more contact notifications may also be stored. Such a parameter selected by the user using a user-interface device.

Upon receiving a location-based contact notification from at least one of the plurality of identified sources, wherein the notification includes location information about a contact, the method may transform the location information of the contact notification into a standardized format. In addition, the computer implemented method may provide to the user-interface device a geographic map, displaying at least one marker on the map representative of the contact associated with the notification, wherein each of the at least one marker indicates a location of a contact based on the location information of that contact. The foregoing steps of collecting, transforming, eliminating, resolving, consolidating, storing of each contact data record and predefined notification parameter, and receiving may be performed on at least one computer processor.

In some cases, the collecting of contact information may be responsive to receiving a user request to aggregate the contact information of the user from the plurality of identified sources. Optionally, the method may involve receiving a user notification for posting user information to at least one contact via at least one of the plurality of sources, converting the user notification into a source format, and posting the user notification to the at least one contact via the at least one of the plurality of identified sources. Such a user notification may include location information about the user, and/or a length of time for display associated with the location information.

Embodiments may extend to a computer system for managing contact information relating to contacts of a user. Such a system may include a processor, a memory coupled to the processor, the memory comprising computer readable program code embodied therein that, when executed by the processor, causes the processor to perform operations comprising any of the foregoing methods, processes, or embodiments.

### BRIEF DESCRIPTION OF THE DRAWINGS

The accompanying drawings, which form a part of the specification, illustrate some of the embodiments disclosed herein. The drawings and description together serve to fully explain the embodiments.

FIG. 1 is a block diagram of systems, methods and computer program products for aggregating, managing, and displaying contact information, according to some embodiments.

FIG. 2 is a flowchart of operations for aggregating contact information according to some embodiments.

FIG. 3 is a user-interface displaying contact data records for a user's contacts, according to some embodiments.

FIG. 4 is a flowchart of operations for updating contact data records, according to some embodiments.

FIG. 5 is a flowchart of operations for displaying contact information, according to some embodiments.

FIG. 6 is a user-interface for displaying contact information via markers on a geographic map, according to some embodiments.

FIG. 7 is a user-interface for displaying information for a respective contact upon user selection of a respective marker in FIG. 6.

FIG. 8 is a user-interface for displaying listings of user contacts, according to some embodiments.

FIG. 9 illustrates the user-interface of FIG. 6 wherein the displayed map is of a larger geographical area than that illustrated in FIG. 6.

FIG. 10 is a user-interface that can be displayed within a user-interface device and that allows a user to control various settings related to contact information aggregation, management, and display, including turn on and off the data from various social networks, email accounts, and mobile phones, according to some embodiments.

FIG. 11 is a user-interface that can be displayed within a user-interface device and that allows a user to view contacts on a map and manage lists of contacts, according to some embodiments.

FIG. 12 is a user-interface that can be displayed within a user-interface device and that allows a user to become notified of contacts that have moved into a predetermined geographical area, according to some embodiments.

FIG. 13 illustrates a contact data record in a standardized format, according to some embodiments.

FIG. 14 is a block diagram that illustrates details of a processor and 30 memory that may be used to aggregate, manage, and display contact information, according to some embodiments.

FIG. 15 is a flowchart of operations for managing notifications associated with a post by a user contact according to some embodiments.

FIG. 16 is a user-interface that can be displayed within a user-interface device and that allows a user to control various settings related to contact information aggregation, management, and display, according to some embodiments.

FIG. 17 is a user interface that can be displayed within a user-interface device and that allows a user to control various settings related to predefined notification parameters that govern what types of location notifications are received by a user device, according to some embodiments.

FIG. 18 is a user interface that can be displayed within a user-interface device and that represents a push notification interface that receives location-based notifications including location information, according to some embodiments.

FIG. 19 is a user-interface that can be displayed within a user-interface device and that represents an application notification interface that receives location-based notifications including location information, according to some embodiments.

FIG. 20 is a user-interface that can be displayed within a user device and that represents a marker displayed on a geographic map that maps location-based notifications.

FIG. 21 is a user-interface that can be displayed within a user device and that represents a marker displayed on a geographic map, according to some embodiments.

FIG. 22 is a user-interface that can be displayed within a user device and that represents an application notification interface in the form of a contact's Recent Activity page, according to some embodiments.

FIG. 23 is a user-interface that can be displayed within a user device and that represents a geographic map that maps location-based notifications, according to some embodiments.

FIG. 24 is a user-interface that can be displayed within a user device and 30 that represents a drop down menu of present locations from which the user can chose to identify the specific location information for the location-based notification, according to some embodiments.

FIG. 25 is a user-interface that can be displayed within a user device and that represents a duration of time for the location-based notification to remain displayed on a contact's user interface, according to some embodiments.

FIG. 26 is a user-interface that can be displayed within a user device and that represents data entry field for adding text to include with the location-based notification, according to some embodiments.

FIG. 27 is a further illustration of interface in FIG. 26 and represents a variety of social networks that may be selected.

FIG. 28 is a further illustration of interface in FIG. 26 and represents a selection of a GUI control to make the post private.

FIG. 29 is a further illustration of interface in FIG. 26 and represents an SMS user interface for sending a limited communication, such as an SMS text message.

FIG. 30 is a user-interface that can be displayed within a user device and that represents the exemplary results of the hyperlink in FIG. 29, according to some embodiments.

FIG. 31 is a user interface that can be displayed within a user device and that represents a confirmation page of the user's transmission of location-based notification including location information, according to some embodiments.

FIG. 32 is a flowchart of operations for transmitting a location-based notification, according to some embodiments.

FIG. 33 illustrates a comparison of location data for the same place taken from two social networks and transformed into standardized data, according to some embodiments.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines may illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when a feature or element is referred to as being “on” another feature or element, it can be directly on the other feature or element or intervening features and/or elements may also be present, in contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

As used herein, phrases such as “between X and Y” and “between about X and Y” should be interpreted to include X and Y. As used herein, phrases such as “between about X and Y” mean “between about X and about Y.” As used 30 herein, phrases such as “from about X to Y” mean “from about X to about Y.”

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations in use or operation in addition to the orientation depicted in the figures.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) and phrases used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by twenty percent (20%).

The term “information”, as used herein, refers to any data that can be transferred electronically including, but not limited to, status updates (such as Facebook updates, LinkedIn updates, Twitter updates, etc.), businesses details or announcements, events, news, open jobs, classifieds, and/or reviews of local businesses.

The term “content”, as used herein, refers to any textual, visual or aural material including, but not limited to, audio, text, photos, videos, animations, and/or references (e.g., hyperlinks and hashtags).

The term “post”, as used herein, refers to any electronic or online transmission of information or content. One type of post is a geographic post (referred to sometimes by persons of skill in the art as a “geopost”) that includes location information such as latitude and longitude coordinates, a location name, and/or a location address. Geoposts are often utilized in social networking and in many other online tools to include location information along with post content.

The term “check-in” refers to a type of post that occurs at a temporary and/or a current location of a contact that is not a permanent location, such as work location or home location. Work location and home location are generally referred to as more permanent in nature, such that any update or post regarding a change in work location or home location may generate automatic notifications.

The terms “contact” and a user's “connection”, as used herein, are interchangeable and are intended to include persons and organizations that may be contained in a user's address book, in a user's email account, in a user's mobile phone address book, in a user's social network list, etc. In some cases, the terms are relative with a user being associated with having aggregated or collected contact information as provided herein, and a “contact” not necessarily being a user of the Connect method and system. Further, the “Connect” system may include various disclosed embodiments, whether methods, systems, non-transient computer readable media or products implementing a method or process, program storage devices, user interfaces, etc.

The phrase “electronic address”, as used herein, means any email address, telephone number, subscriber identification (CSID or TSID), instant messaging address, handle, or the like that often includes a unique sequence of numbers and/or letters chosen by and/or assigned to an individual (user and contact) and represent that individual's contact information.

The phrase “out-of-town contact”, as used herein, means any user contact whose home location and/or work location differs from the user's home location and/or work location, respectfully.

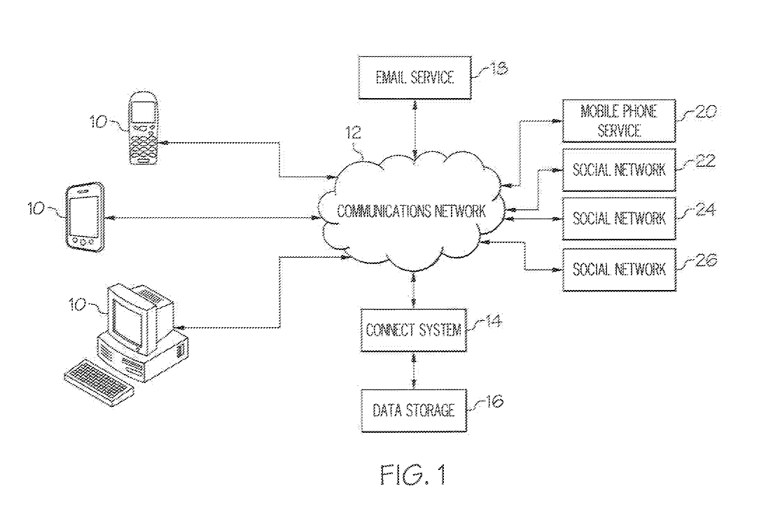

Referring now to the figures, systems, methods and computer program products for aggregating, managing, and displaying user contact information and location-based notifications, according to some embodiments of the present invention, will be described. FIG. 1 is a block diagram illustrating various user devices 10 (e.g., mobile devices, desktop computing devices, etc., also referred to as user-interface device) that communicate with a Connect system 14 via a communications network 12, such as the Internet. An aspect of the Connect system 14 may be considered a computer system, including a computer processor specifically configured for methods to aggregate and synchronize a user's contact information from multiple, user-selected sources, such as an address book from the user's email service 18, a signature block from a contact's email to the user, an address book from the user's mobile phone service 20, and one or more social networks 22-26. The Connect system 14 unifies contact data, location data, and data, such as education history, work history, relationship status, personal interests, group memberships, notes, and tags into one contact profile and stores a respective encrypted data record for each contact in data storage 16. In addition, embodiments of the Connect system 14 allow users to search and display contacts on a geographic map, via various devices 10. It will be understood that the system 14 may be implemented as a method or process using at least one computer, and that such a computer may, for example, provide or transmit content to various devices 10, by the system, such as a map for a user-interface of device 10. Moreover, embodiments of the Connect system 14 allow users to receive from, and transmit to, contacts location-based notifications and other user information.

The Connect system 14 may be implemented in a “cloud” computing environment. Cloud computing is a computing paradigm where shared resources, such as processor(s), software, and information, are provided to computers and other devices on demand typically over a network, such as the Internet. In a cloud computing environment, details of the computing infrastructure, e.g., processing power, data storage, bandwidth, and/or other resources are abstracted from the user. The user does not need to have any expertise in or control over such computing infrastructure resources. Cloud computing typically involves the provision of dynamically scalable and/or virtualized resources over the Internet. A user may access and use such resources through the use of a Web browser. A typical cloud computing provider may provide an online application that can be accessed over the Internet using a browser. The cloud computing provider, however, maintains the software for the application and some or all of the data associated with the application on servers in the cloud, i.e., servers that are maintained by the cloud computing provider rather than the users of the application.

The Connect system 14 (e.g., Web, and Native Mobile) may provide or utilize the same API (Application Programming interface), which acts as a communication layer between the servers and databases where users' contact data may be stored. The servers, databases, and API may be considered a “backend” of the Connect system 14. By having all versions (mobile app, mobile web browser, tablet web browser, PC web browser) of the Connect system 14 utilize the same backend, the data between all platforms may be always synchronized (as it is always the same data). This allows a user to access all of his/her contact information from anywhere the user is able to log into his/her connect system account.

Embodiments of the Connect system 14 may include two primary conceptual components: (A) an aggregated address book of processed contact information stored as contact data records in the data storage 16, and (B) a location-based notification system that in some embodiments includes a user interface (e.g., of device 10) having a geographic map of location-based contact information.

### Contact Information Aggregation

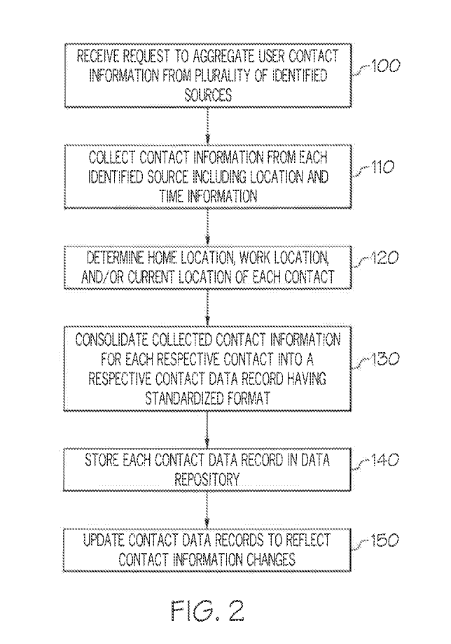

Referring to FIG. 2, operations that the Connect system 14 performs to aggregate user contact information, according to some embodiments of the present invention, will be described. Initially, a request may be received from a user to aggregate the user's contact information from one or more identified sources (Block 100). For example, the user may have an address book of contacts associated with an email service and/or associated with a mobile phone service. In addition, the user may be a member of one or more social networks such as, for example, Facebook, Twitter, Foursquare, Instagram, etc., and may maintain a respective list of contacts having contact information on each respective social network. In the request, the user identifies which source(s) contact information is to be collected from. Alternatively, this may be effected upon registration, activation of a source account, or incorporated with other means.

Responsive to the user request, contact information is collected from each identified source (Block 110). Typically, the collected information of contacts includes identification, an image, and location information for each contact, such as home location, work location, etc., from where the contact has recently checked-in or posted status updates or photographs, etc., and the collected information is parsed and prioritized to determine a home location, work location, and/or check-in location of each contact (Block 120). The words “each contact” are intended to convey an objective, but not an absolute, in that some contact information may incomplete, corrupted, or unusable. In other embodiments, “each” may refer to each contact within a group or subset of contacts selected by a user or other person for that source. Location information collected from an address book of an email service may include a home location and/or a work location of a contact. In addition, location information collected from a social network may include a home location and/or a work location of a contact. A social network may also include location information about a check-in location of a contact. For example, a contact may be traveling and may have posted his/her location information on a social network, such as Facebook, which creates a location-based notification that can be received by the system. In some embodiments, the various collected location information for each contact may be converted or transformed into latitude and longitude coordinates for use in displaying contact information on a geographical map, as will be explained below.

In some cases, embodiments of the Connect system 14 can pull updated contact information from a contact's email to the user. For example, an email signature block may contain contact information (e.g., phone number, address information, etc.) that can be imported by the Connect system 14.

Collected contact information may include various types of information in addition to location information. For example, contact information may include information about a contact's identity, education, work history, and personal interests. In addition, contact information may include information about the contact's family and/or friends. In addition, a time stamp may be associated with contact information as it is collected. As such, the home, work, and/or current location of a user can be associated with points in time, particularly as the contact information is updated over time (Block 150). This will facilitate allowing a user to display contact information on a geographical map for selected time frames, as will be explained below.

Information collected for each contact is consolidated into a respective contact data record (Block 130) and stored in a data repository (Block 140). This step may include transforming the collected information into a standardized format, eliminating duplicated information, resolving conflicting information and merging, aggregating, or consolidating multiple records of the same individual into one combined contact data record with respect to a contact. For example, a user may be friends with a person on Facebook and may have various information about the person stored on Facebook. The user may also have contact information for the same person in a mobile phone address book. Thus, duplicate information, such as workplace, phone number, etc., is likely to exist. The Connect system 14 is configured to compare specific data points to calculate a level of confidence that a person associated with imported contact information from one source is the same person that is associated with imported contact information from a second source. If the determination is made that it is the same person/contact, the contact information from the multiple sources is consolidated into a single data record.

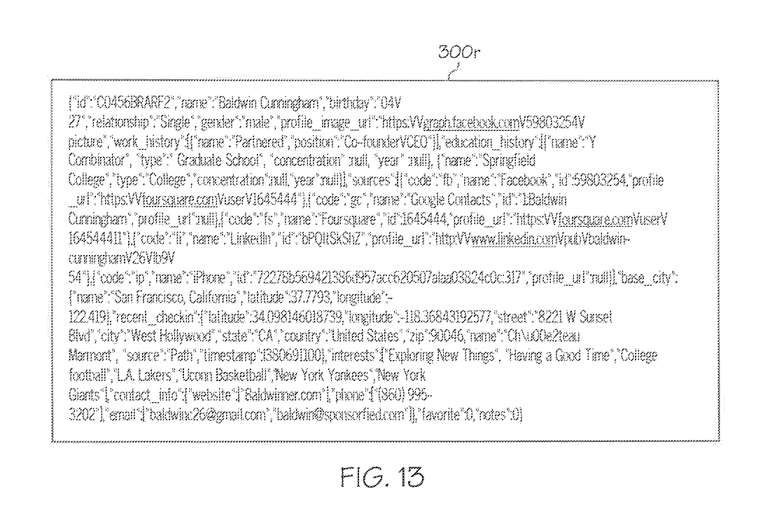

Consolidation also includes transforming collected contact information into a standardized format. FIG. 13 illustrates an exemplary contact data record 300r in a standardized format, according to some embodiments of the present approach. The steps of collecting contact information, transforming the collected contact information into a standardized format, eliminating duplicate information, and resolving conflicting information may all be performed on at least one computer processor; additional detail of these steps is provided below in the discussion of processing contact notification, which is similar.

Contact data records may be updated periodically to reflect contact information changes (Block 150) of the respective contact. For example, the Connect system 14 may periodically determine (e.g., hourly, daily, weekly, etc.) for each contact data record if information has changed at one or more of the sources from where the contact information was originally collected. If information has changed, the Connect system 14 may update the contact data record with the more recent or more complete information. For example, in addition to being capable of identifying changes to address information, telephone information, and the like, the Connect system 14 also is capable of detecting if a contact is presently in a different geographic location (i.e., if the current location information has changed).

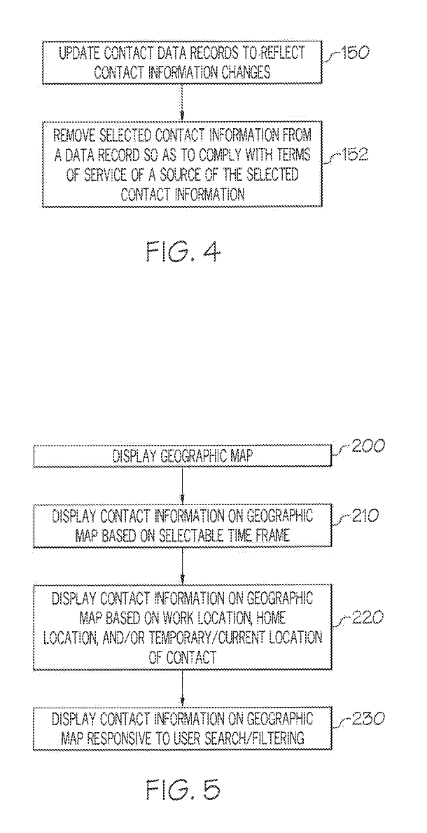

Referring to FIG. 4, updating contact data records (Block 150) may also include removing selected contact information from a data record so as to comply with terms of service of a source of the selected contact information (Block 152). For example, LinkedIn, a professional social network, may require integration partners like the Connect system 14 to refresh contact data every twenty four hours. As such, the Connect system 14 is configured to refresh contact data as appropriate based on the terms of service of the source of the contact data.

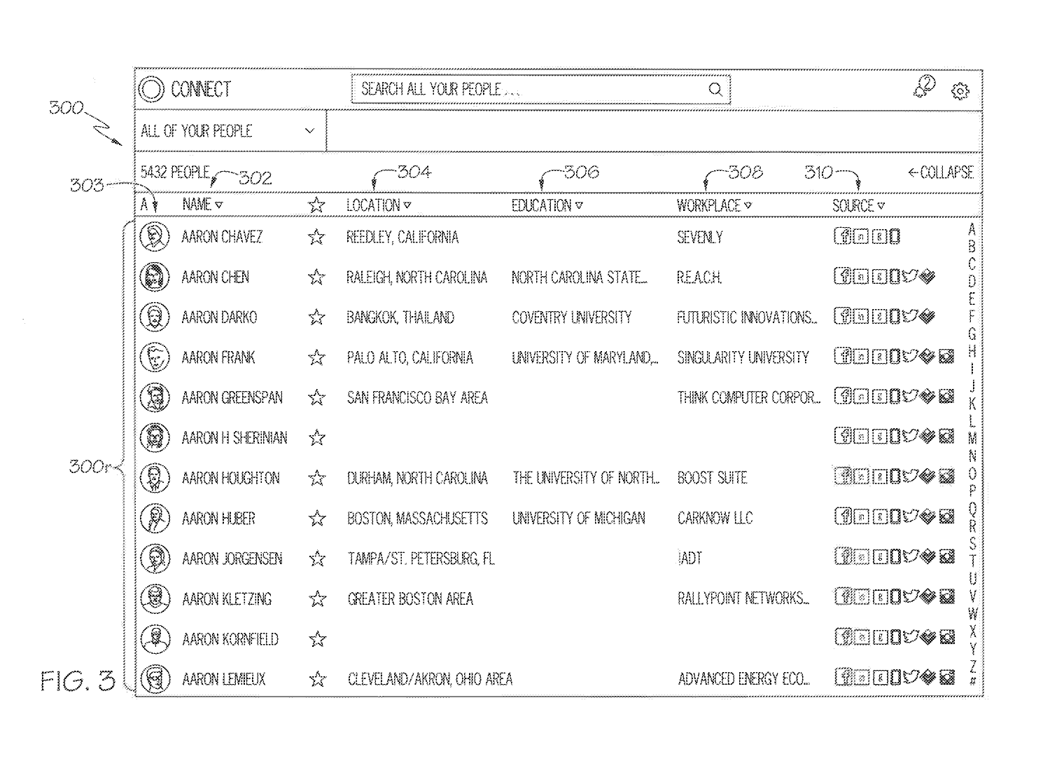

FIG. 3 is a user interface 300 that displays contact data records 300r for a user's contacts that have been created by the Connect system 14. In the illustrated embodiment, each record 300r may include a contact name 302, along with an image and/or icon 303 of the contact, location information 304, education information 306, and workplace information 308. Each contact record 300r also includes an identification of the sources 310 used to collect contact information and build each record 300r. Embodiments of the present invention are not limited to the information displayed in FIG. 3. Various other types of contact or source information may be utilized in a contact data record 300r.

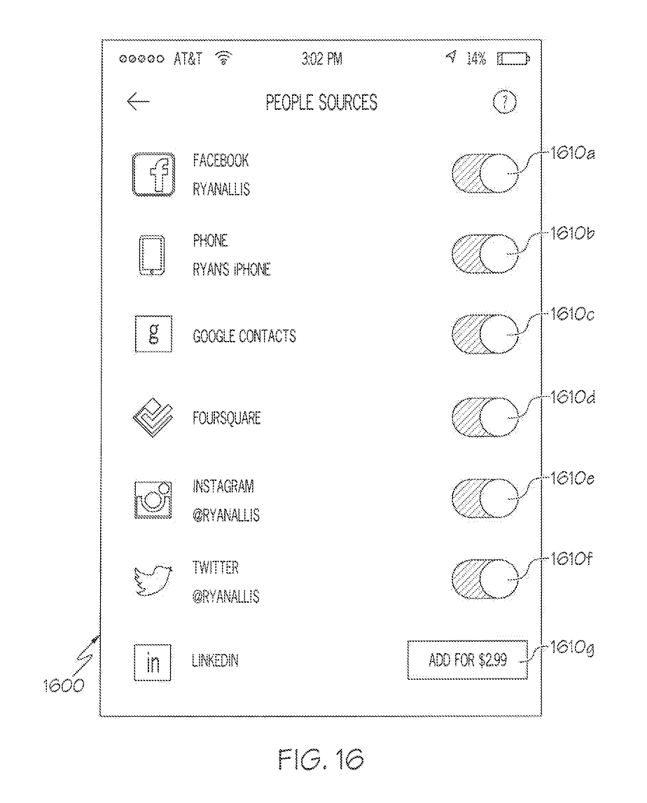

In aggregating location information of a user's contacts, one or more operations outlined in FIG. 2 may be utilized. FIG. 16 is a user interface 1600 according to some embodiments of the present system and method, that can be displayed within a user device 10 (e.g., mobile phone and/or smart phone) and that allows a user to control various settings related to contact information aggregation, management, and display, including turn on and off the data or information from one or more of the various social networks, email accounts, and mobile phones (i.e., “plurality of identified sources”).

In the depicted embodiment, graphical user interface (or “GUI”) controls 1610a-1610g allow a user to turn on and off contact information or data from various sources. For example, GUI control 1610a controls the collection and display of data from social network Facebook, GUI control 1610b controls the collection and display of data from a user's iPhone, GUI control 1610c controls the collection and display of data from Google Contacts, GUI control 1610d controls the collection and display of data from social network Foursquare, GUI control 1610e controls the collection and display of data from social network Instagram, GUI control 1610f controls the collection and display of data from social network Twitter, and GUI control 1610g controls the collection and display of data from LinkedIn with a link for payment of a fee.

The Connect method and system 14 in some cases may utilize the application programming interface (API) from the social networks when available. In addition, a specific user's contact information can be collected from a variety of sources including, but not limited to, location-based information and location-based notifications. For example, a home location may be collected from Facebook and/or LinkedIn. Geolocated posts may be collected from Facebook and/or Instagram. Check-in posts may be collected from Foursquare. Home location and other contact information may be collected from Google Contacts and/or a user's phone. The present connect method and system aggregates location information collected from various social networks, email accounts, and mobile phones (i.e., “plurality of identified sources”), allowing location information or data originally generated across a variety of platforms to be assimilated and transformed for use with the Connect system 14.

In some embodiments, location information is collected from a plurality of identified sources, including across multiple social networks, and is transformed into a normalized or standardized format. In one example, geolocation data collected from LinkedIn does not presently include longitude or latitude information. The Connect method and system 14 may include a geocoding system to standardize location information for a contact that is represented in the same format (e.g., lat/long), such as for a work location or home location. In another example, two identified sources may both use the same format for location information (e.g., Facebook and Instagram both utilize lat/long data), but the two may have different coordinates for the same location. The Connect system 14 standardizes the latitude and longitude coordinates to communicate and/or display the exact same point, as described herein. In various embodiments, the Connect system 14 may collect and transform a variety of location data including, but not limited to latitude and longitude, place name, and address for each geographic post.

### Contact Information Display

Referring to FIG. 5, the present method and Connect system 14 may be configured to display user contact information by geographic location. For example, the embodiment of the Connect system 14 displays a geographic map (Block 200) and displays markers on the map, wherein each marker is representative of a user selected contact. The Connect system 14 may display contact information on a map (e.g., via markers) based on a selectable time frame (Block 210). For example, a map may be displayed that includes a user selectable time frame (e.g., the last twenty-four hours, the last two days, the last three days, etc.). User selection of a time frame causes each marker to be displayed on the map at the most recent check-in location (i.e., a form of location information) of each respective contact during the selected time frame. For example, if a contact who lives in New York City checked in to San Francisco in the past twenty four hours and the user selects this time frame, a marker for the contact is displayed on the map in San Francisco. Various embodiments of location-based notifications are disclosed herein, and may allow a user to identify a contact that is within a certain distance of the user, the user's home location, the user's work location, or identify when the user contact is traveling or has change the contact's own home location and/or work location.

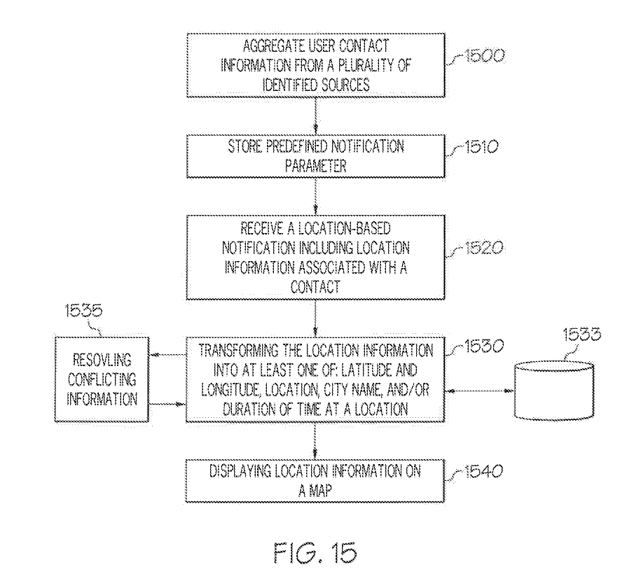

In some embodiments, contact information is displayed on the map based on work location, home location, and/or check-in location of a contact (Block 220). For example, for each contact, a marker may be displayed on the map at the contact's work address, home address, and/or current address if different from the work address and home address. In some embodiments, contact information is displayed on the map in response to a location-based notification generated from a contact's post as more fully outlined in FIG. 15.

In some embodiments, contact information is displayed on the map in response to user search and/or filter criteria (Block 230). For example, a user may want to display contacts based upon some search/filter criteria, such as where a contact went to school, where a contact lives, etc. For example, a user can display on a map all contacts who went to Harvard Business School, all contacts who live in San Francisco, all contacts who work at Google and have CTO in their job title, etc. In some embodiments, a user can display on a map contacts from a selected source, such as a particular social network (e.g., display only Facebook friends).

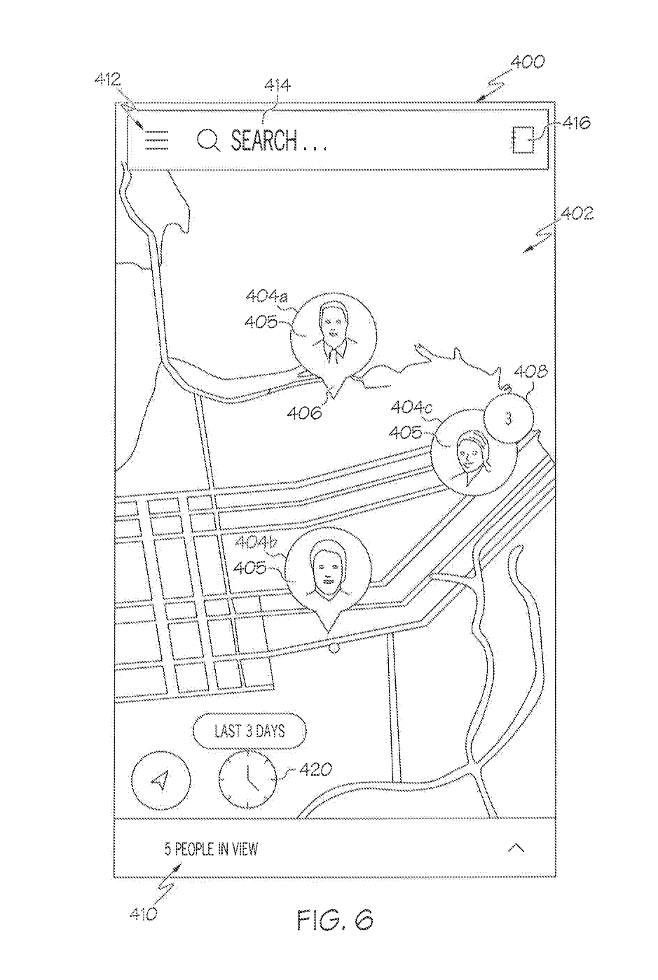

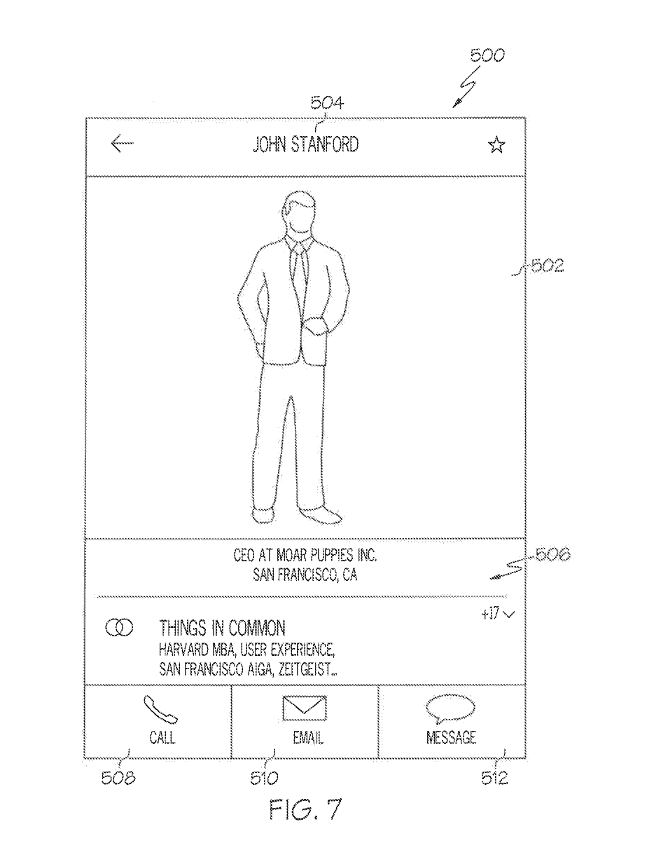

FIG. 6 illustrates an exemplary user interface 400 displayed within a user device 10 that displays contact information on a geographic map 402, according to some embodiments of the present method and system. The illustrated map 402 is shown with markers 404a, 404b, 404c that represent a user's contacts in the displayed geographical area. Markers 404a-404c each include an image 405 of a respective contact and also include a pointer 406 that points to a location (e.g., home, work, etc.) on the map 400 for the contact.

The illustrated user interface 400 includes a lower portion 410 and an upper portion 412, The lower portion may include various information about the displayed geographical area and/or about the contacts displayed on the map 402. In the illustrated embodiment, the user interface lower portion 410 contains information that five (5) people are in view on the displayed map 402. In the illustrated embodiment, the user interface clock 420 contains information that the contact information includes the most recent data over the last three (3) days. The illustrated upper portion 412 includes a search window 414 and a GUI control 416 or link. The search window 414 allows a user to search for additional contacts in the displayed geographical area. The search function enables users to search for contacts by name, location, workplace, job titles, schools attended, interests, relationship status, gender, etc.

The illustrated GUI control 416, when activated by a user, allows a user to display a list of the contacts that match any active search criteria and/or other lists of the user's contacts. For example, FIG. 8 illustrates a list 602 of all of a user's contacts displayed within a user interface 600. The illustrated list 602 is displayed in alphabetical order, although the list 602 may displayed/filtered in various other ways.

The illustrated user interface of FIG. 8 also includes a search window 604 and a GUI control 606. The search window 604 may allow a user to search for any contacts that the user has by name, location, workplace, job titles, schools attended, interests, relationship status, gender, etc. The illustrated GUI control 606, when activated by a user, may display the user interface 400 illustrated in FIG. 6. As such, the user can toggle between a geographical map 402 displaying contact information (FIG. 6) and a listing of user contacts (FIG. 8) by activating GUI controls 416 (FIG. 6) and 606 (FIG. 8).

Returning to FIG. 6, marker 404c represents multiple contacts that are in close geographical proximity with each other within the displayed map 402. When multiple contacts are in close proximity, the Connect system 14 may create a single marker to represent a “cluster” of markers, and selects a single image of a contact from the contacts within that cluster to use as the marker image, A number may be overlaid (represented by bubble 408) on the marker 404c to indicate the number of contacts represented by the marker 404c. In the illustrated embodiment, the marker 404c represents three (3) contacts who are in close proximity with each other in the displayed geographical area.

In some embodiments, a color border may be utilized around one or more of the marker images 405 to indicate whether a particular marker (404a-404c) represents particular location information, such as a permanent location for a contact or a temporary location for the contact. For example, a marker for a contact that is displayed at the contact's home address may have a black border and a marker for the contact that is displayed at a current location of the contact (e.g., a contact that is visiting another location) may have a red border, Various colors may be utilized to indicate permanent locations and temporary locations. Moreover, various ways of having a marker indicate permanent locations and temporary locations may be utilized, according to various embodiments of the present method and system. For example, a marker may utilize indicia other than color, such as shading, shapes, patterns, etc., to indicate types of contact locations.

In some embodiments, each marker (e.g., 404a-404c, FIG. 6) displayed within a map is user selectable and enables the user to call, email, and/or message a contact represented by the marker. For example, a user could select the marker 404b displayed within the map 402 of FIG. 6 and initiate a phone call with the contact represented by the marker, send an email to the contact represented by the marker, send a text message to the contact represented by the marker, etc.

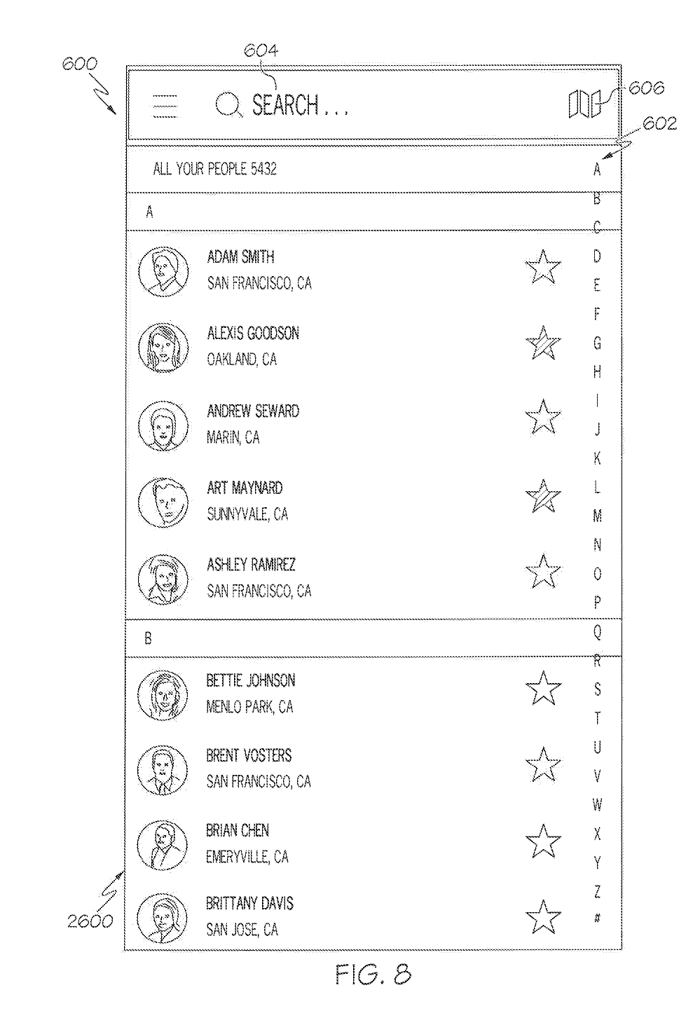

FIG. 7 illustrates an exemplary user interface 500 displayed within a user device 10 as a result of selection of a respective marker (e.g., 404a-404c in FIG. 6). The illustrated user interface 500 displays an image 502 and identity or name 504 of the respective contact, along with information 506 about the contact. In addition, the illustrated user interface 500 allows the user to call the contact via GUI control 508, send an email to the contact via GUI control 510, and/or send a message to the contact via GUI control 512.

In some embodiments, a map may be displayed with sliding time scale capability which acts as a filter for contact markers on a displayed map (e.g., map 402 in FIG. 6). The sliding scale represents a range of time and, as a user slides the scale, the Connect system 14 utilizes a timestamp included with the contact data to display markers that fall within the selected range of time. For example, in FIG. 6, a user can adjust a time scale via GUI control 420. In the illustrated embodiment of FIG. 6, a user has selected a time frame of the last three days. As such, markers for any of the user's contacts that have been in the selected geographical area in the last three days are displayed.

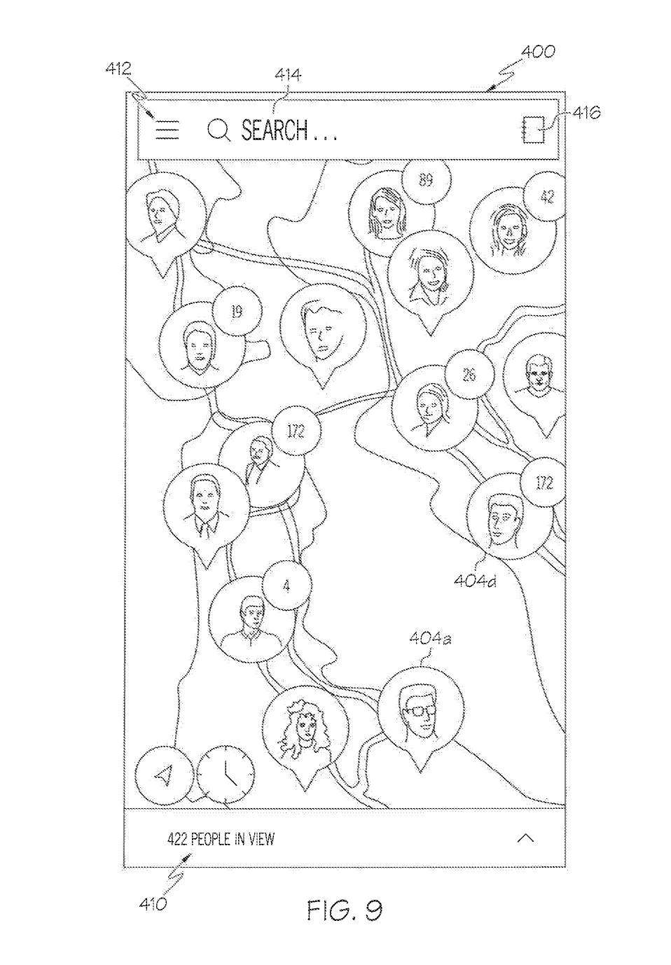

FIG. 9 illustrates the user interface 400 of FIG. 6 wherein the view of displayed map 402 is expanded to a larger geographical area than that illustrated in FIG. 6. Because of the larger geographical area, there are more user contacts located within the area as represented by the larger number of markers. As displayed in the lower portion 410 of the user interface 400, four hundred twenty two (422) people are represented by markers in the map 402. In addition, there are many contacts in close proximity to each other within the displayed area. For example, marker 404d represents a cluster of one hundred seventy two (172) contacts.

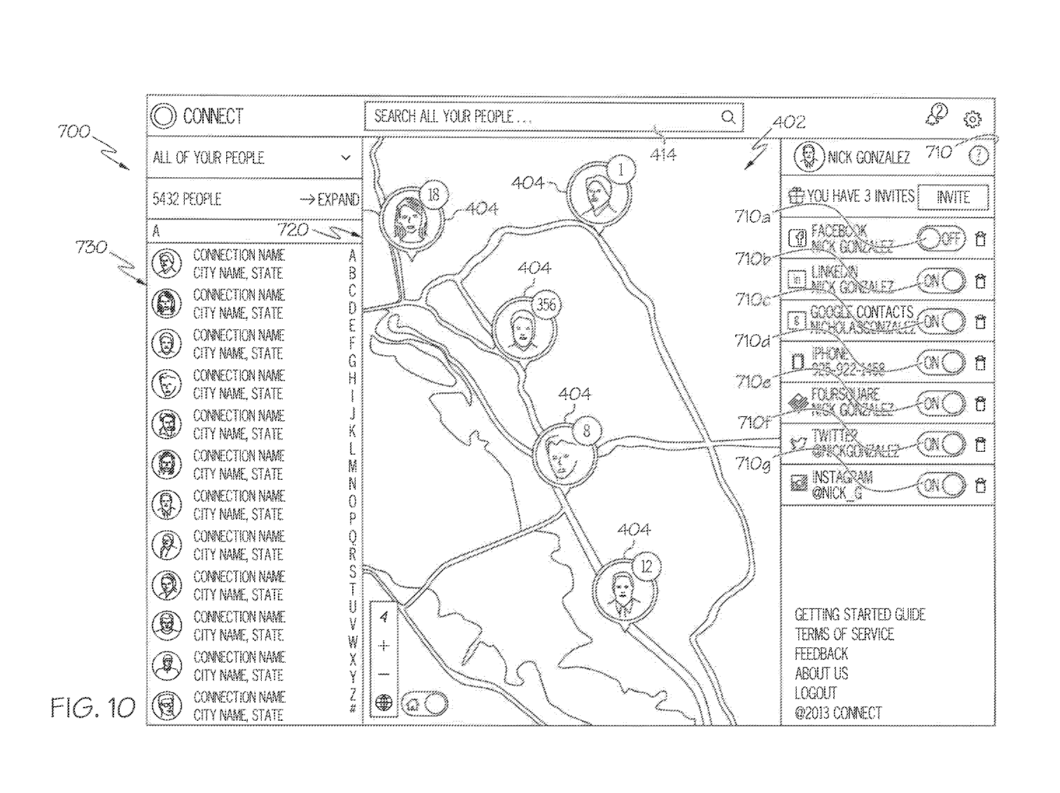

FIG. 10 is a user interface 700, according to some embodiments of the present computer implemented method and system, that can be displayed within a user device 10 and that allows a user to control various settings related to contact information aggregation, management, and display, including turning on and off the data from various social networks, email accounts, and/or mobile phones. The illustrated user interface 700 includes a first portion 710, a second portion 720, and a third portion 730. In the illustrated embodiment, the first portion 710 is located on the right side of the user interface 700, the second portion 720 is located in the middle of the user interface 700, and the third portion 730 is located on the left side of the user interface 700. However, the first portion 710, second portion 720, and third portion 730 may be displayed within user interface 700 in various locations. Embodiments of the method and system are not limited to the illustrated location of the various portions 710-730.

The illustrated first portion 710 includes GUI controls 710a-710g that allow a user to turn on and off contact data from various sources. For example, GUI control 710a controls the collection and display of data from social network Facebook. GUI control 710b controls the collection and display of data from social network LinkedIn, GUI control 710c controls the collection and display of data from Google Contacts, GUI control 710d controls the collection and display of data from an iPhone address book, GUI control 710e controls the collection and display of data from social network Foursquare, GUI control 710f controls the collection and display of data from social network Twitter, and GUI control 710g controls the collection and display of data from social network Instagram. The illustrated second portion 720 includes a selected geographical map 402 and various markers 404 representing contacts displayed there within, as described above. The illustrated third portion 730 includes an alphabetical listing of a user's contacts.

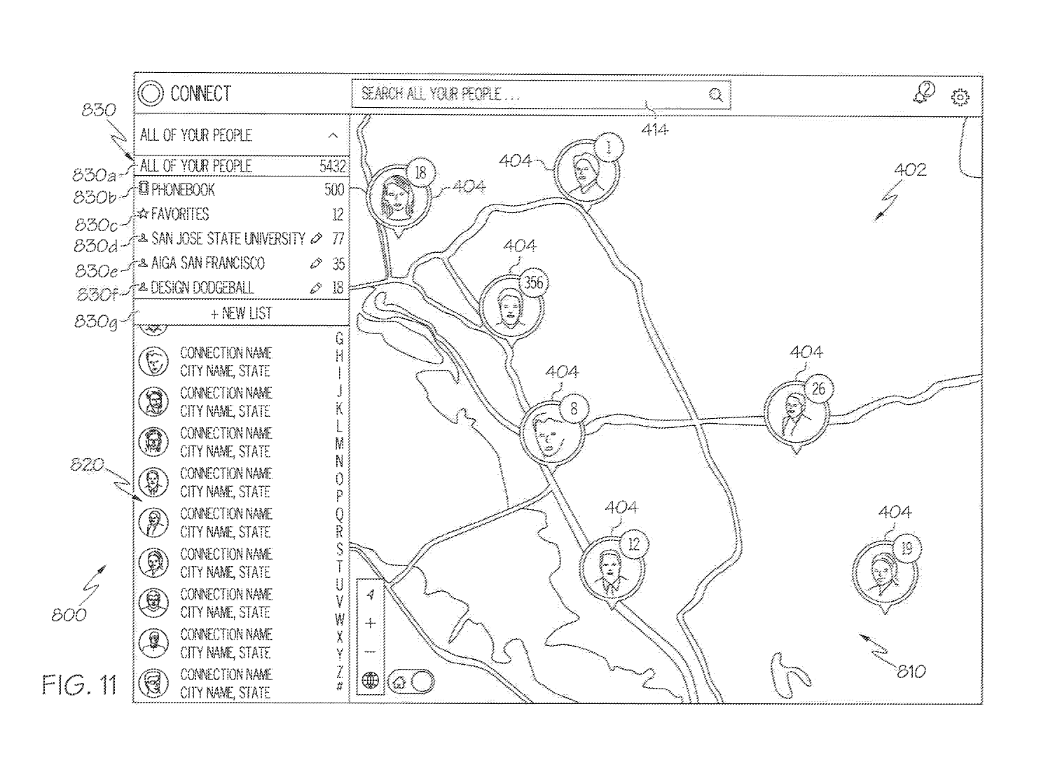

FIG. 11 is a user interface 800 that can be displayed within a user device 10 and that allows a user to view their contacts on a map and manage lists of contacts, according to some embodiments of the method and system. The illustrated user interface 800 includes a first portion 810, a second portion 820, and a third portion 830. The first portion 810, second portion 820, and third portion 830 may be displayed within user interface 800 in various locations. Embodiments of the method and system are not limited to the illustrated location of the various portions 810-830. The illustrated first portion 810 includes a selected geographical map 402 and various markers 404 representing contacts displayed there within, as described above. The illustrated second portion 820 includes an alphabetical listing of a user's contacts.

The third portion 830 of user interface 800 includes GUI controls 830a-830g for allowing a user to manage lists of contacts, for example a list of contacts displayed within the second portion 820 and/or displayed on the map 402 in the first portion 810. In the illustrated embodiment, GUI control 830a enables a list of all of a user's contacts to be displayed within the second portion 820 and/or on the map 402 in the first portion 810, GUI control 830b enables a list of a user's phonebook contacts to be displayed within the second portion 820 and/or on the map 402 in the first portion 810, GUI control 830c enables a list of as user's favorite contacts to be displayed within the second portion 820 and/or on the map 402 in the first portion 810, GUI control 830d enables a list of a user's contacts associated with San Jose State University to be displayed within the second portion 820 and/or on the map 402 in the first portion 810, GUI control 830e enables a list of a user's contacts associated with AIGA San Francisco to be displayed within the second portion 820 and/or on the map 402 in the first portion 810, and GUI control 830e enables a list of a user's contacts associated with Design Dodgeball to be displayed within the second portion 820 and/or on the map 402 in the first portion 810.

In the illustrated embodiment, each GUI control 830a-830f is configured to display a total number of contacts associated with each respective list. For example, in the illustrated embodiment, GUI control 830c associated with a user's favorite contacts displays the number twelve (12). In the illustrated embodiment, the displayed third portion 830 of user interface 800 also includes a GUI control 830g that enables a user to create new lists of contacts.

The Connect method and system 14 may use a notification system configured to notify the user via a push notification on a mobile phone, an email, or within a connect system interface that a contact, who is not from within a predetermined distance (e.g., 100 miles, etc.) of the user's area, has entered the area that they live in with a check-in, and/or a contact has permanently moved their home from one location to another. This system is utilized to assist the user in knowing when their contacts from out of town are nearby or have changed home locations. The underlying data for this location change may be automatically updated and synchronized within the relevant contact record 300r.

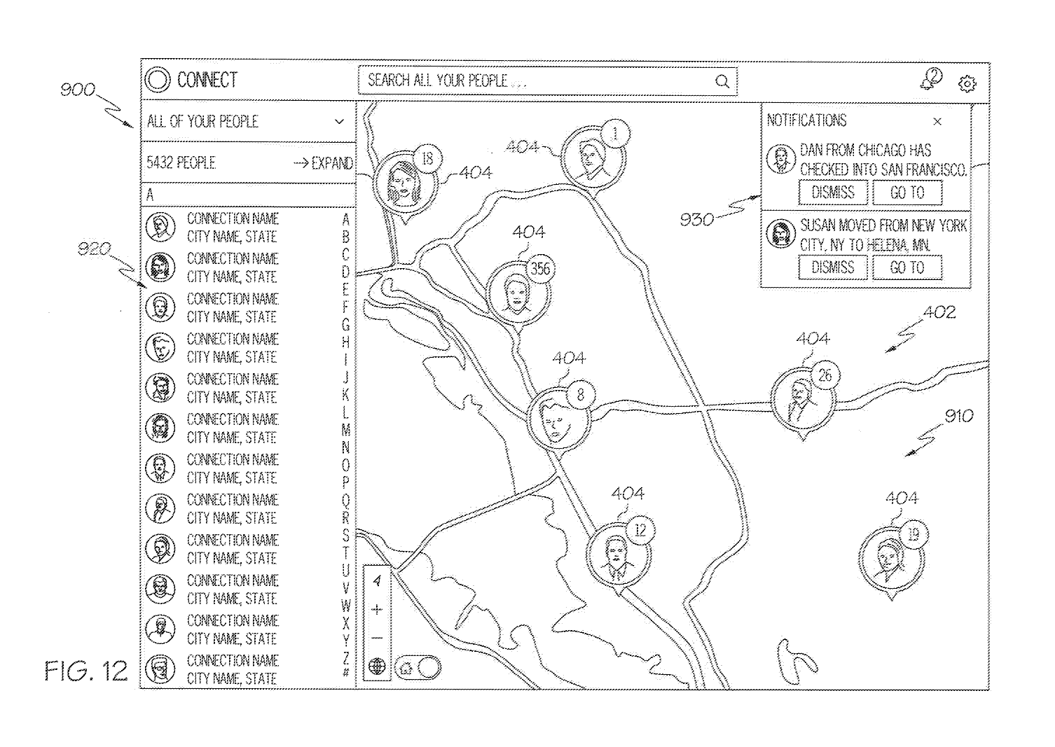

FIG. 12 is a user interface 900 that can be displayed within a user device 10 and that allows a user to become notified of contacts that have moved into a predetermined geographical area. The illustrated user interface 900 includes a first portion 910, a second portion 920, and a third portion 930. The first portion 910, second portion 920, and third portion 930 may be displayed within user interface 900 in various locations. Embodiments of the present method and system are not limited to the illustrated location of the various portions 910-930. The illustrated first portion 910 includes a selected geographical map 402 and various markers 404 representing contacts displayed there within, as described above. The illustrated second portion 920 includes an alphabetical listing of a user's contacts. The third portion 930 is a notifications window that provides information regarding contacts that have moved into a predetermined geographical area, for example, a geographical area where the user is located.

In some embodiments of the method and system, each user of the Connect system 14 can create and maintain a contact information profile for themselves that can be shared with other individuals. When a user updates their contact information profile, that person's contact information may automatically update for all users of the Connect system 14.

In some embodiments of the method and system, two users of the Connect system 14 can exchange contact information with each other via their mobile phones, adding contact information for the respective person to the other person's connect system list(s) and mobile phone.

in some embodiments of the method and system, a geographic map (e.g., 402, FIGS. 6, 9, 10-12) is used to visually display the location of social network status updates (such as Facebook updates, LinkedIn updates, Twitter updates, etc.), businesses, events, news content, open jobs, classifieds, and/or reviews of local businesses such as restaurants, dentists, and/or coffee shops,

In some embodiments of the method and system, a geographic map (e.g., 402, FIGS. 6, 9, 10-12) is used for business, not-for-profit, and/or government purposes to visually display other types of geographically mapped information augmented with data from social networks including the location information of customers, leads, employees, suppliers, donors, and/or voters along with a profile for each record that allows the user to view aggregated contact information.

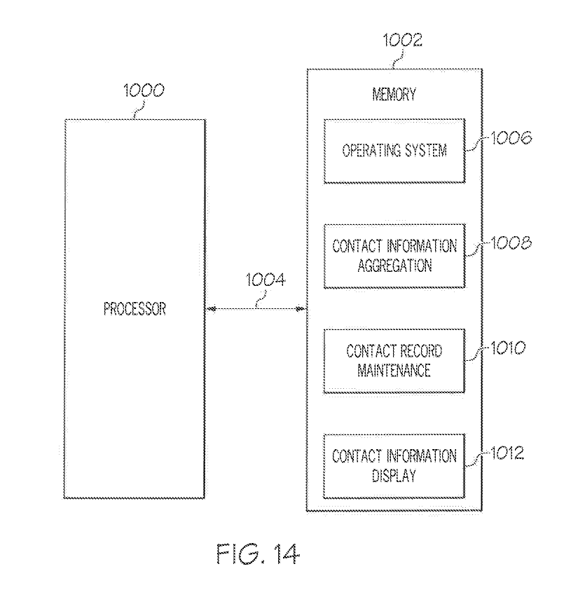

FIG. 14 illustrates an exemplary processor 1000 and memory 1002 that is representative of one or more connect system servers in accordance with embodiments of the present method and system, Embodiments are not limited to a single processor and memory. Multiple processors and/or memory may be utilized, as would be understood by those skilled in the art. The processor 1000 and memory 1002 may be utilized to aggregate contact information into data records, update data records, manage communications with sources, etc., and display contact information as described above. The processor 1000 communicates with the memory 1002 via an address/data bus 1004. The processor 1000 may be, for example, a commercially available and/or custom microprocessor and/or similar data processing device. The memory 1002 is representative of the overall hierarchy of memory devices containing the software and data used to perform the various operations described herein, and may constitute a data repository controlled by processor 1000. The memory 1002 may include, but is not limited to, the following types of devices: cache, ROM, PROM, EPROM, EEPROM, flash, SRAM, and/or DRAM.

As shown in FIG. 14, the memory 1002 may hold various categories of software and data: an operating system 1006, a contact information aggregation module 1008, a contact record maintenance module 1010, and a contact information display module 1012. The contact information aggregation module 1008 comprises logic or program code for collecting or receiving contact information from various sources, consolidating the information into standardized data records, and for storing the data records, as described above. The contact record maintenance module 1010 comprises logic for updating contact data records, as described above. The contact information display module 1012 comprises logic for displaying contact information on a geographical map, as described above.

### Receiving Location-Based Notifications

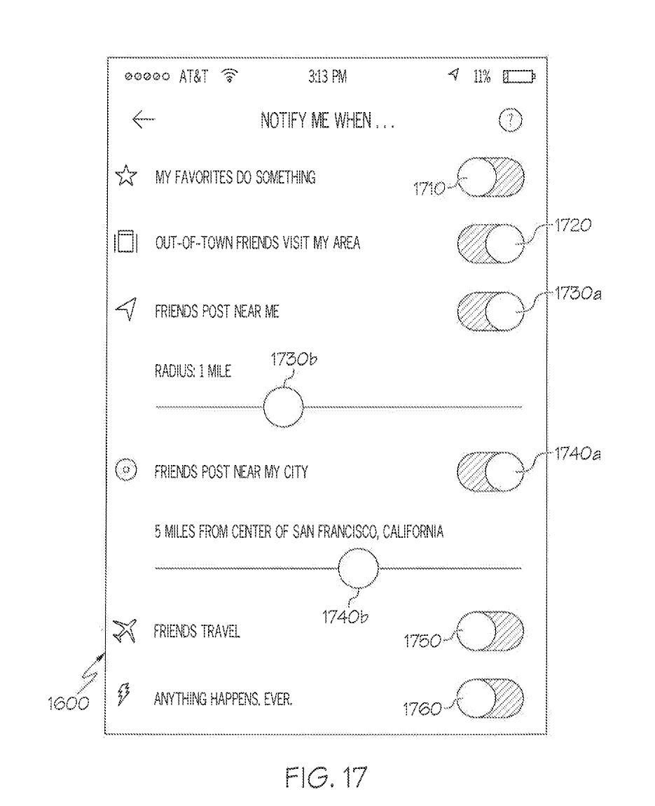

Referring to FIGS. 15 and 17, FIG. 15 is a flowchart of operations for managing notifications associated with a post by a user's contact, according to some embodiments of the present method and system (i.e., in a manner similar to the collecting of contact information). FIG. 17 is a user interface that can be displayed within a user device and that allows a user to control various settings related to predefined notification parameters that govern what types of location notifications are received by a user device, according to some embodiments.

The Connect method and system 14 may be configured to allow a user to select and store (Block 1510) within the data storage 16 a number of predefined notification parameters. In one embodiment, the Connect method and system 14 aggregates or collects user contact information from a plurality of identified sources (Block 1500). FIG. 17 is a mobile user interface 1700, according to some embodiments of the method and system, that can be displayed within a user device 10 (e.g., mobile phone and/or smart phone) and that allows a user to control various settings related to predefined notification parameters that govern what types of location notifications are received by a user device 10. The location-based notifications of the Connect system 14 are collected from geoposts commonly generated though social network platforms. Geoposts include, but are not limited to, a post and/or check-in through Facebook, Instagram, Foursquare, Connect, or other social tools or sources, and that include location information along with the post content (e.g., text, photo, video, and audio). Geoposts can be generated through social networks external to the Connect system 14 or through the Connect system 14. The Connect method and system 14 comprises a number of predefined notification parameters from which a user can select types of notifications that may be received by a user device 10 including, but not limited to, the identity of the contact generating the post, the contact generating the post being at a predetermined distance to the user, the contact generating a post proximate to the user's city, an out-of-town contact generating a post proximate to the user, the contact generating a post indicating the contact is traveling, the contact generating a post indicating a change in home location, the contact generating a post indicating a change in work location, a favorite contact generating a post, and/or a predetermined or network group contact generating a post. In FIG. 17, GUI controls 1710-1760 allow a user to turn on, turn off, and/or adjust, among others the parameters (e.g., location and/or distance) of the types of notifications received by a user device 10.

In the illustrated embodiment, GUI control 1710 controls the receipt of notifications from a post generated by a contact designated by the user as a favorite; GUI control 1720 controls the receipt of notifications from an out-of-town contact that generates a post in proximity to the user's area (based on a signal to and/or from the user's device 10); GUI control 1730a controls the receipt of notifications from a contact that generates a post at a predetermined distance near the user (based on a signal to or from the user's device 10); GUI control 1730b controls the radius of predetermined distance between the user (based on a signal to or from the user's device 10) and the post generated from the contact defined by GUI control 1730a; GUI control 1740a controls the receipt of notifications from a contact who generates a post proximate to the user's city (based on work location, home location, and/or current location); GUI control 1730b controls the radius of the proximate distance between the post generated by the contact and the user's city defined by GUI control 1740a; GUI control 1750 controls the receipt of notifications from a contact that generates a post indicating the contact is traveling (e.g. where the contact posts location-based information that differs from the contact's home location or work location); and GUI control 1750 controls the receipt of notifications from any contact that generates any post. Embodiments of the present method and system are not limited to a “user's” location, as it is to be understood that in various example embodiments, a “user's location” may be based on a signal to or from the user's device 10.

In some embodiments, one or more of the predefined notification parameters of the Connect method and system 14 may be separately modified for each user contact. In some embodiments, the Connect system automatically stores default parameters including, for example, “out-of-town” being defined as not within 100 miles of the user's and/or contact's home location and when out-of-town contacts post within the user's area, the area is defined within 30 miles of the user's home location; and for contacts posing while traveling, “traveling” may be defined as more than 500 miles away from the contact's home location.

Referring to FIG. 15, operations that the Connect method and system 14 performs to receive a location-based notification (or contact information), according to some embodiments, will be described. Initially, user contact information is aggregated or collected from a plurality of identified sources as outlined in detail above (Block 1500). Once the Connect system 14 has aggregated contact information to the point of storing a contact data record for at least one contact, notifications can be received from that at least one contact. In some embodiments, predefined notification parameters may be selected by a user and stored (Block 1510) by the Connect method or system 14 in a data storage 16 prior to any receipt of location-based notifications. In other embodiments, the Connect system 14 automatically stores default parameters.

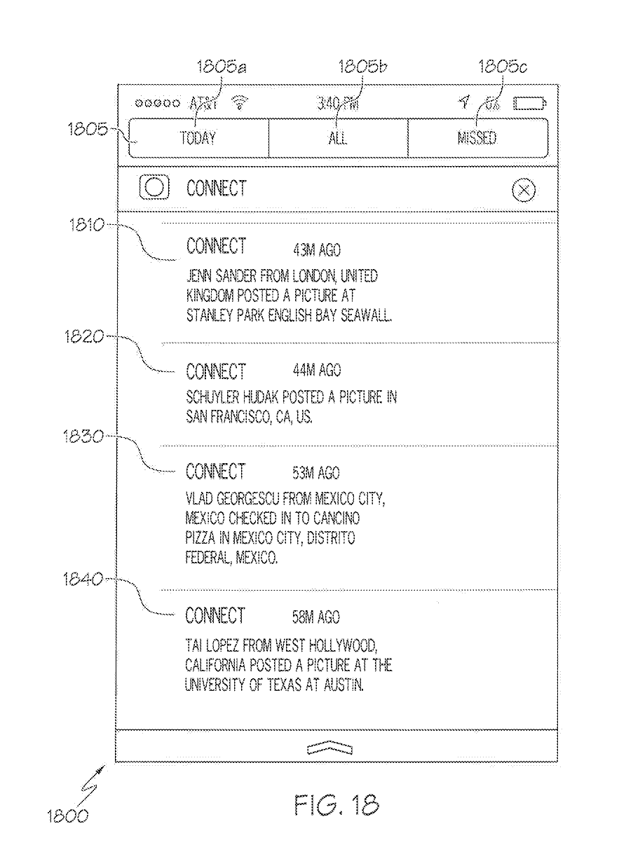

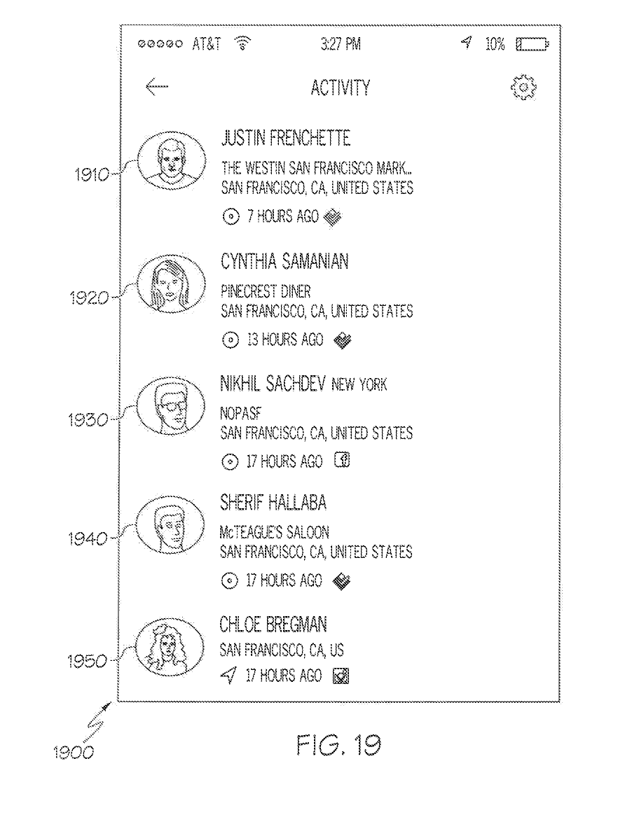

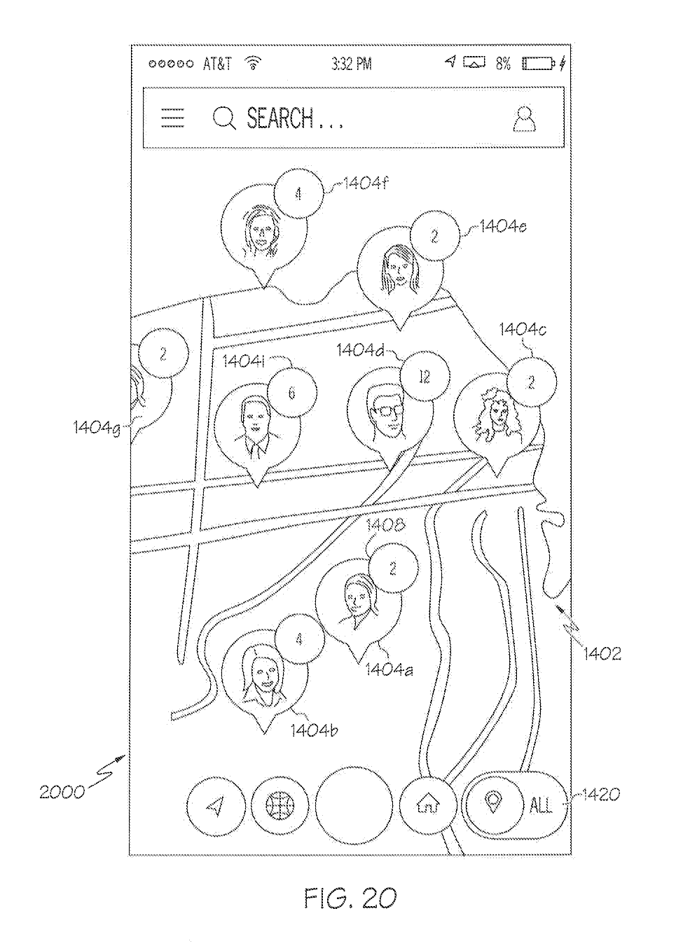

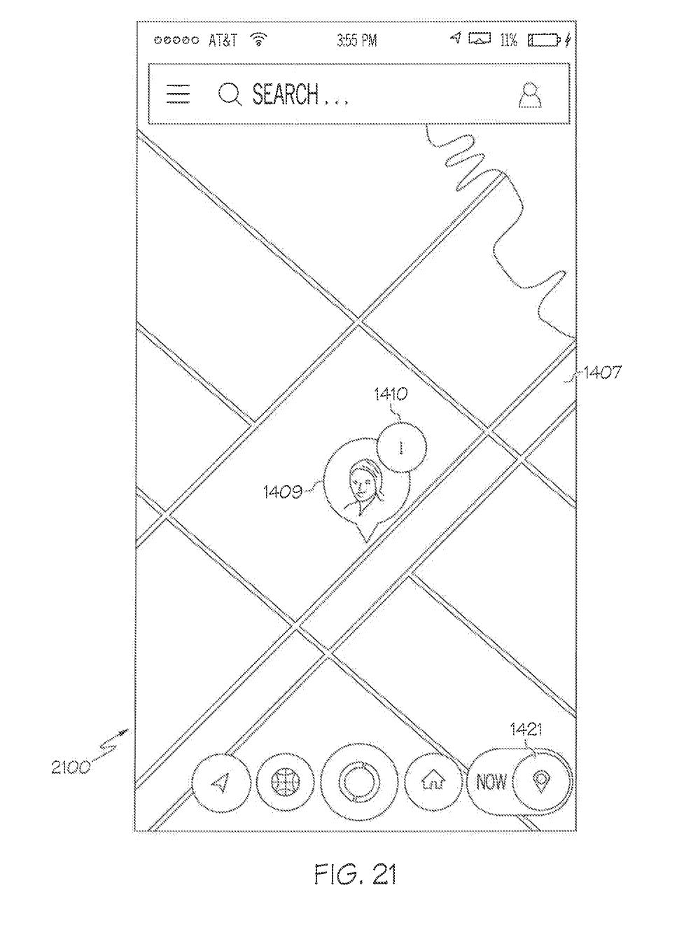

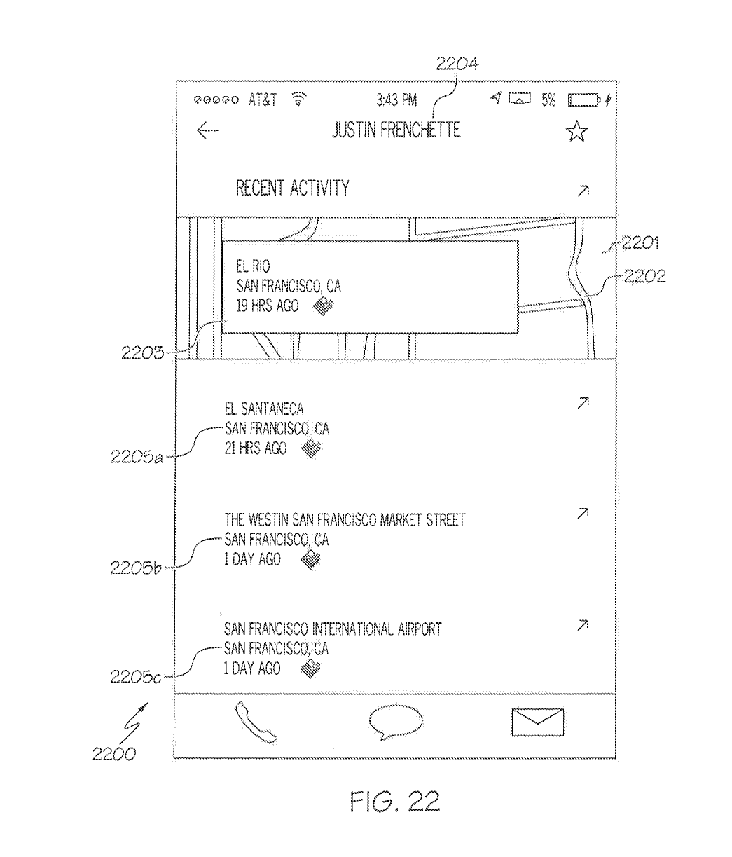

Receipt of a location-based contact notification including location information associated with the contact (Block 1520) may include any one or more of a push notification, such as a SMS text message, an email, an application messenger service (FIG. 18), and/or a computer-generated voicemail; an application notification (FIGS. 19 and 22); and/or a marker displayed on a geographic map (Block 1540; FIGS. 20 and 21).

Note that in various embodiments, the location-based notification may optionally include or be integrated with the location information. In some embodiments, the location-based notification and location information are separate and/or are transmitted separately.

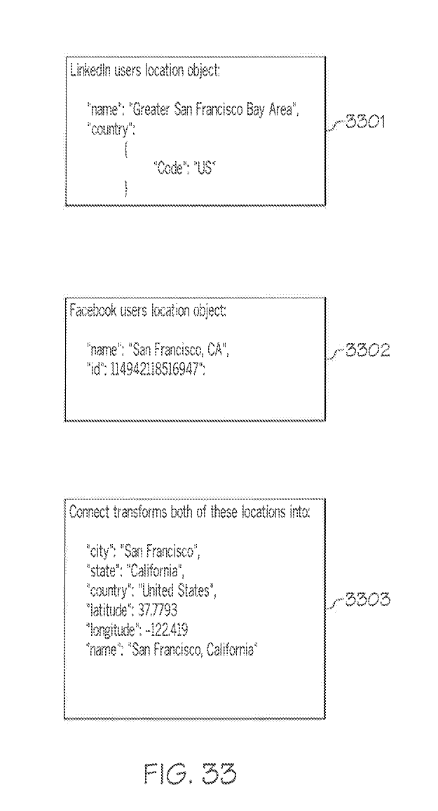

As noted above, receipt of a location-based notification including location information from a variety of sources, particularly from a variety of social networks, may necessitate transforming (Block 1530) the location information into a standardized format, such as at least one of the following types of information: latitude and longitude, location name, location address, city name, and/or duration of time at location. For example, nonstandard format information (e.g., a name of a city) may be identified and transformed to a desired format (e.g., latitude and longitude) based on a reference database having a nominal or corresponding latitude and longitude for that city (Block 1533). In some cases, formatted location information of a contact may be a duplicate, such that the method and system may eliminate duplicated information within the contact information. In some embodiments, the method and system will resolve or reconcile two or more sets of location information or data having the same format and generally identifying the same location, but with different data points (Block 1535). This disparity of data points can occur, for example, if two social networks (e.g., Facebook and Instagram) both utilize latitude and longitude format, but the two social networks have different coordinates for the same location. The Connect method and system 14 may select one set of latitude and longitude coordinates to communicate and/or display the exact same point. In some embodiments, the method and system may assign a confidence factor to location information as a function of the source, timeliness, and/or nature of the location information, thereby establishing a hierarchy of location information. Resolving conflicting information may comprise identifying and selecting location information having the highest confidence factor. Confidence factors may be determined from an empirical or experience of historic performance or a similar decision on accuracy by source or location and source, or in contrast, to some extent dynamically, i.e., in a predictive manner for a new location, such as by Bayesian analysis of the sources or a combination of history and prediction. FIG. 33 that illustrates a comparison of location information for the same place taken from two sources or social networks (i.e., LinkedIn 3301 and Facebook 3302) and transformed into standardized format data 3303 for the Connect system 14. As noted above, this process is similar whether for a contact notification or for the initial collection of contact information, though it is contemplated that contact notification from a single source may present a lesser need for resolving conflicting information than cross source contact information.

FIG. 18 is a user interface 1800 that can be displayed within a user device 10 and that represents a push notification interface that receives location-based notifications having location information. The illustrated user interface 1800 includes a Connect system 14 notification system with various postings 1810-1840 sorted by time. The top menu bar 1805 of the user interface 1800 represents options for postings for “Today” 1805a, “All” 1805b, and “Missed” 1805c.

FIG. 19 is a user interface 1900 that can be displayed within a user device 10, and that represents an application notification interface that receives location-based notifications including location information. The illustrated user interface 1900 includes a Connect method or system 14 having an application Activity Feed notification system with various postings 1910-1950 sorted by time and across the Connect system 14 and other social networks.

FIG. 20 is a user interface 2000 that can be displayed within a user device 10 and that represents markers 1404a-1404i displayed on a geographic map 1402 that maps out location-based notifications. Such maps (and markers) may generally be provided by at least one computer processor supporting system 14 to the user device 10 for use and display in the user interface 2000. In various embodiments, the maps may include all location-based notifications over a given quantity of time. For example, the illustrated map 1402 includes all location-based notifications over the last 3 days, wherein the GUI control 1420 is set to “All” location-based notifications within the illustrated map 1402. The illustrated map 1402 is displayed with markers 1404a-1404i representing location-based notifications from a user's contacts in the displayed geographical area. A number is overlaid (represented by bubble 1408) on the marker 1404a to indicate the number of contacts represented by the marker 1404a, here two (2). In many other respects, the illustrated map 1402 of FIG. 20 includes many of the same features as the illustrated map 402 of FIG. 6.

FIG. 21 is a user interface 2100 that can be displayed within a user device 10 and that represents a marker displayed on a geographic map 1407 that maps out location-based notifications. In various embodiments, the maps may include all location-based notifications over a given quantity of time. For example, the illustrated map 1407 includes all location-based notifications over the last 3 days, wherein the GUI control 1421 is set to “All” location-based notifications within the illustrated map 1407. A number is overlaid (represented by bubble 1410) on the marker 1409 to indicate the number of contacts represented by the marker 1409, here one (1). The Connect system 14 illustrated map 1407 in the present embodiment allows users to see all the geographic posts (e.g., location-based notifications) that are currently active, which is defined as geographic posts that are still currently active based on the duration the contact set when creating the post. If the Connect system 14 receives a geographic post from another source with no duration, the Connect system 14 may assume a default period of time (e.g., two hours) to allow, for example, representation on the “now” map 1407.

FIG. 22 is a user interface 2200 that can be displayed within a user device 10 and that represents an application notification interface in the form of a contact's “Recent Activity” page within the Connect method or system 14. The illustrated user interface 2200 displays a map 2201 with a marker 2202 and box 2203 indicating a location-based notification appearing on the contact's aggregated list of Recent Activity. The contact's name 2204, along with recently posted location-based notifications 2205a-2205c, are also listed about the contact.

### Sending Location-Based Notifications

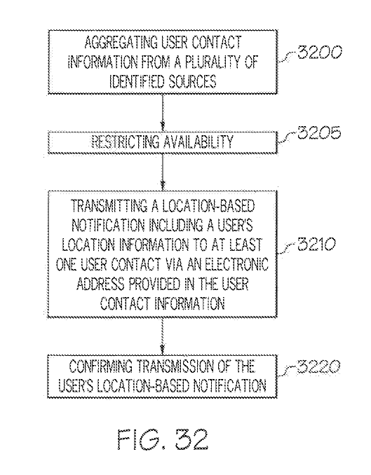

Referring to FIG. 32, embodiments of the Connect method and system 14 may be configured to allow a user to aggregate user contact information from a plurality of identified sources (Block 3200). Once the Connect system 14 has aggregated (i.e., steps of collecting through storing) contact information for at least one contact, then notifications can be transmitted to that at least one contact.

In some embodiments, the Connect system 14 allows a user to transmit (Block 3210) a location-based user notification including a user's location information to at least one contact via an electronic address (i.e., via at least one of the plurality of identified sources) provided in the user contact information. In some embodiments, the transmission of a location-based notification further includes transmitting a user post that may comprise a user post and/or geopost in other words, a contact using the Connect method or system 14 may receive a notification from a user of the Connect method and system 14 (i.e., as a source in relation to the location information provided to the contact.) Information may be shared within the Connect method and system 14, with or without a third party platform. Thus, the terms “user” and “contact” may be construed relatively, with respect to the information being shared or collected, and the person posting or sharing. In some embodiments the user post may include at least one of the following forms of user information: content, user status update, and/or user profile change. In some embodiments, the transmitting an electronic notification includes at least one of the following: a push notification, an application notification, and/or a marker on a geographic map.

In some embodiments, a location-based notification to be transmitted by the user is restricted in availability (Block 3205) before transmission, wherein the availability of the location-based notification including the user's location information is limited to at least one of the following: a select group, a select contact, and/or a select push notification. For example, a user “select group” represents a predetermined group of contacts for whom the user has selected for receipt of certain information, which may include the location-based notifications. Similarly, a “select contact” is a specific contact of whom the user has selected for receipt of certain information including the location-based notification. Moreover, for example, a “select push notification” is a specific type of limited communication that includes at least one of the following: an SMS text message, an email, an application messenger service, and/or a computer-generated voicemail. In a preferred embodiment, the select push notification is an SMS text message.

In some embodiments, the transmission of the user's location-based information is confirmed (Block 3220).

In various embodiments disclosed herein, the Connect method and system 14 may allow a user to create and send (i.e., transmit) location-based notifications or geoposts to contacts on the Connect system 14 and on other social networks or sources by creating the post on Connect. This unique application includes additional features that are converted and/or translated for applicability within a social network other than the Connect system 14. In addition, a user can set a length of time he/she will be in a particular place and incorporate such information within the location-based notification and/or location information. In addition, a user may create and privately transmit location-based notifications (e.g., via SMS) This feature may allow a limited selection of a user's contacts to utilize the “now” function on the contact's map (e.g., 1407 in FIG. 21) to receive location-based notification from the user, where the remaining contacts would not be privy to the user's same privately transmitted location-based notification. Embodiments of the present invention are not limited to these features alone, but may incorporate any feature or combination thereof in an unlimited variation of arrangements.

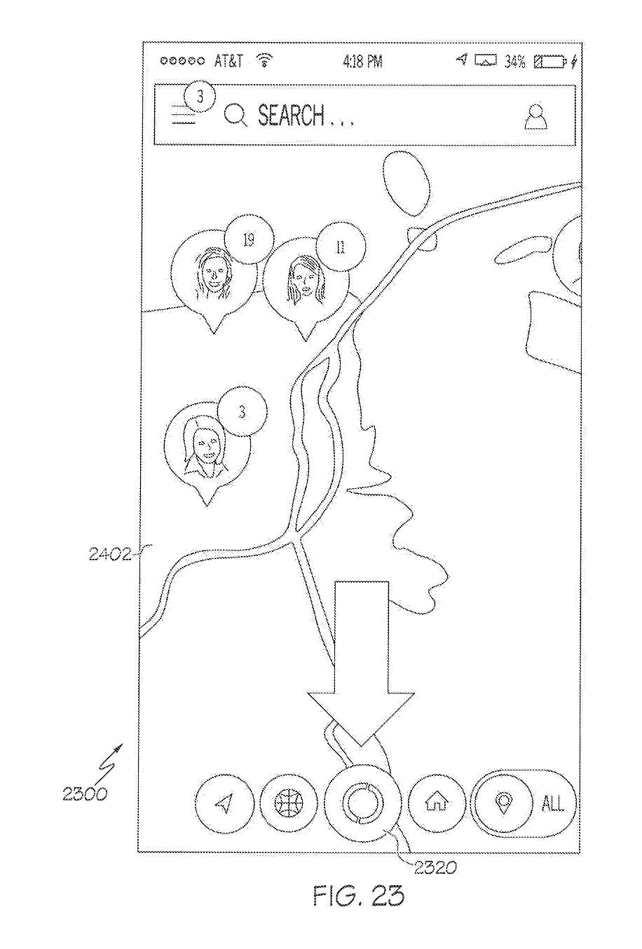

FIG. 23 is a user interface 2300 that can be displayed within a user device 10 and that represents a geographic map 1402 that maps location-based notifications. The GUI control 2320 initiates the transmission process.

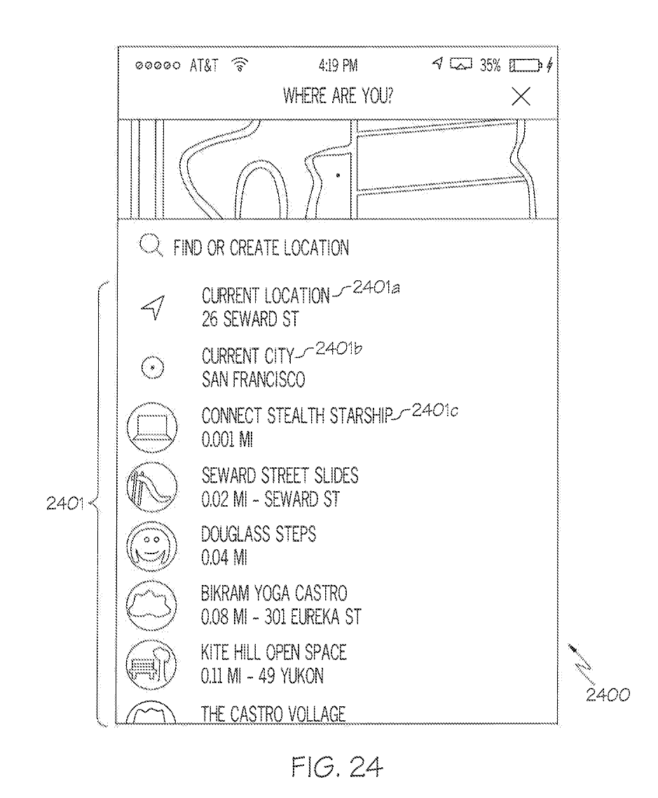

Some embodiments may provide for user selection of location information to be included within a user notification. FIG. 24 is a user interface 2400 that can be displayed within a user device 10 and that represents a drop down menu of present or current locations 2401 from which a user can chose to identify the specific location information for a location-based user notification. The drop down menu options include, inter alia, a specific address 2401a, a city 2401b with no other specific location shared, and a specific place name 2401c.

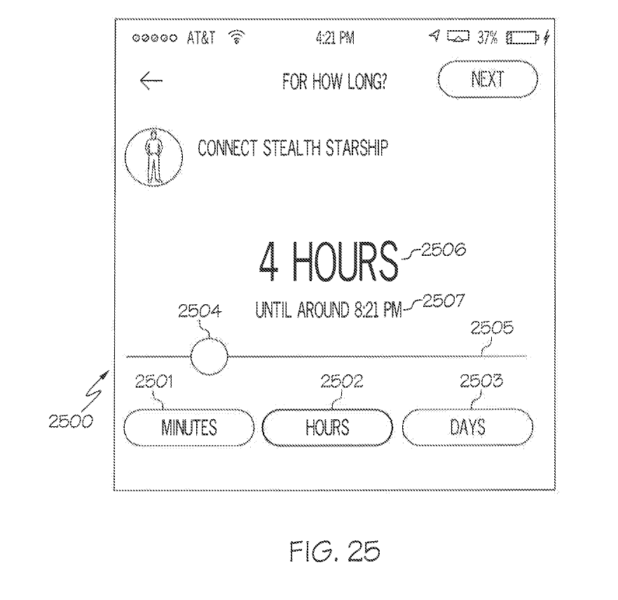

Some embodiments may provide for user selected duration of a user notification. FIG. 25 is a user interface 2500 that can be displayed within a user device 10 and that represents a selectable duration or length of time for the location-based user notification to remain displayed on a contact's user interface (e.g., geographical map 1402); the contact who received the transmission of the location-based user notification will receive the duration or length of time information associated with the location information. The user interface 2500 allows the user to specify the duration of time in minutes via GUI control 2501, in hours via GUI control 2502, in days via GUI control 2501 (particularly, for example, if you are on vacation), and/or on a sliding scale 2505 via GUI control 2504. The selected duration of time is displayed 2506 along with the projected time 2507 when the selected duration of time 2506 will end. If a user's contact were to utilize the “now” function on the contact's map (e.g., 1407 in FIG. 21) and received such a location-based user notification, the contact will continue to see the user's marker (e.g., 1404) for the entirety of the time selected by the user. In some embodiments, the Connect method and system 14 may utilizes a default (e.g., two (2) hours) if no other time is selected by a User. In some embodiments, the Connect method and system 14 may offer a user a range of time to select, possibly between 5 minutes and 100 days.

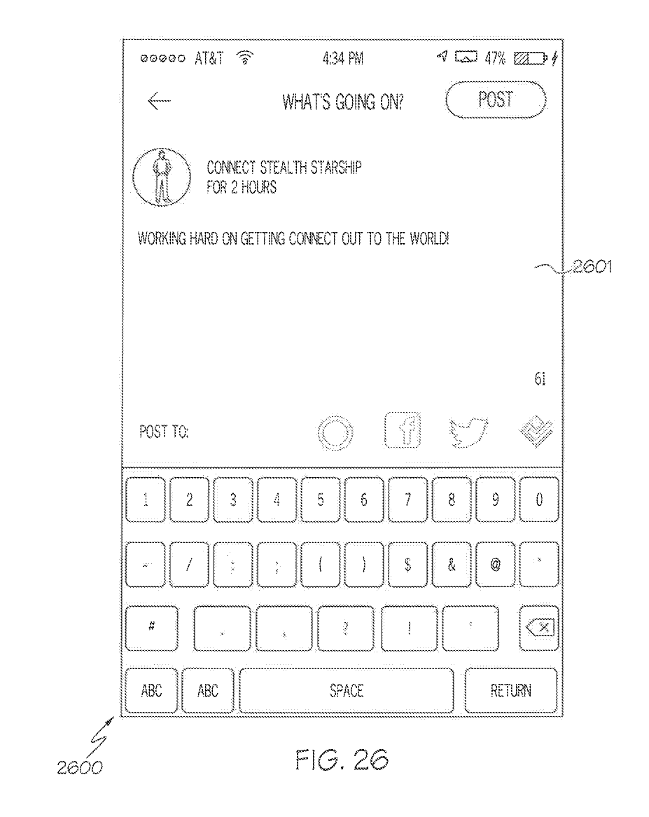

Some embodiments may provide to user an interface permitting content entry with a user notification. FIG. 26 is an example of a user interface 2600 that can be displayed within a user device 10 and that represents a data entry field 2601 for adding text to include with the location-based user notification and/or location information.

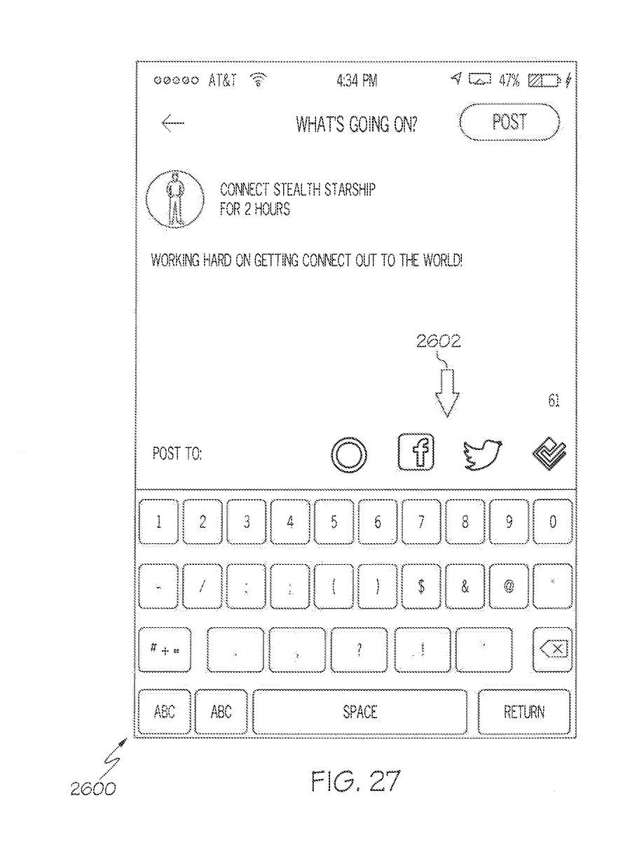

Some embodiments may enable the user to select one or more sources for receipt of a user notification. FIG. 27 is a further illustration of interface 2600 representing a variety of social networks that may be selected by the User for including in the transmission of the location-based user notification, as represented by the arrow 2602.

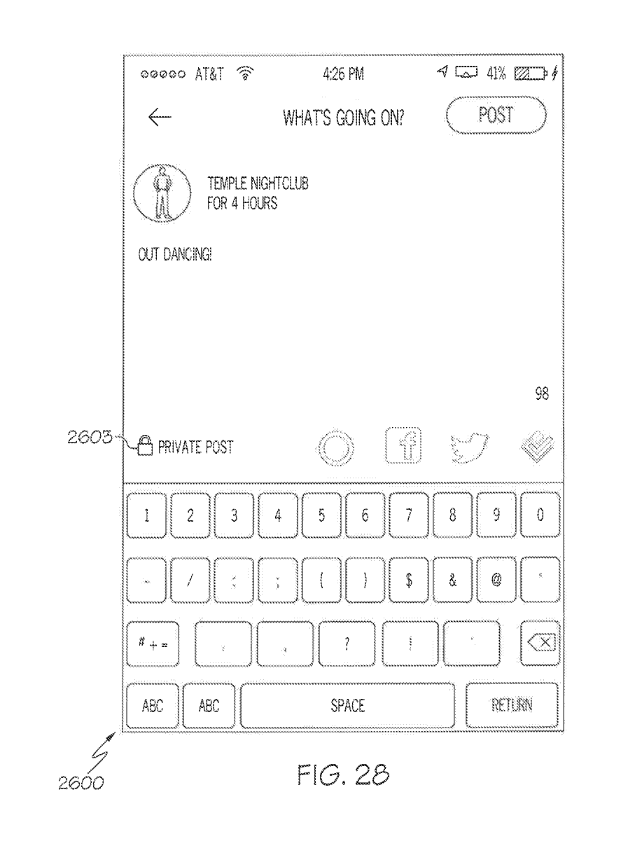

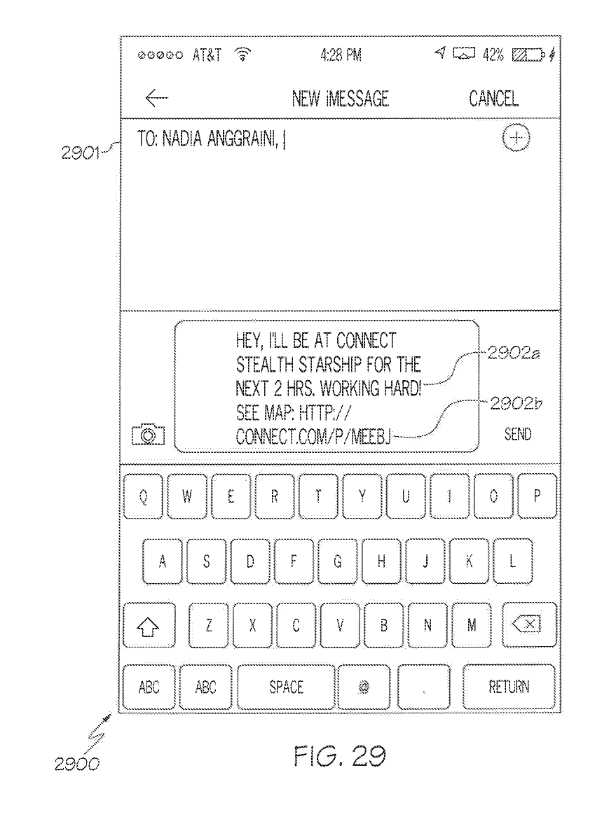

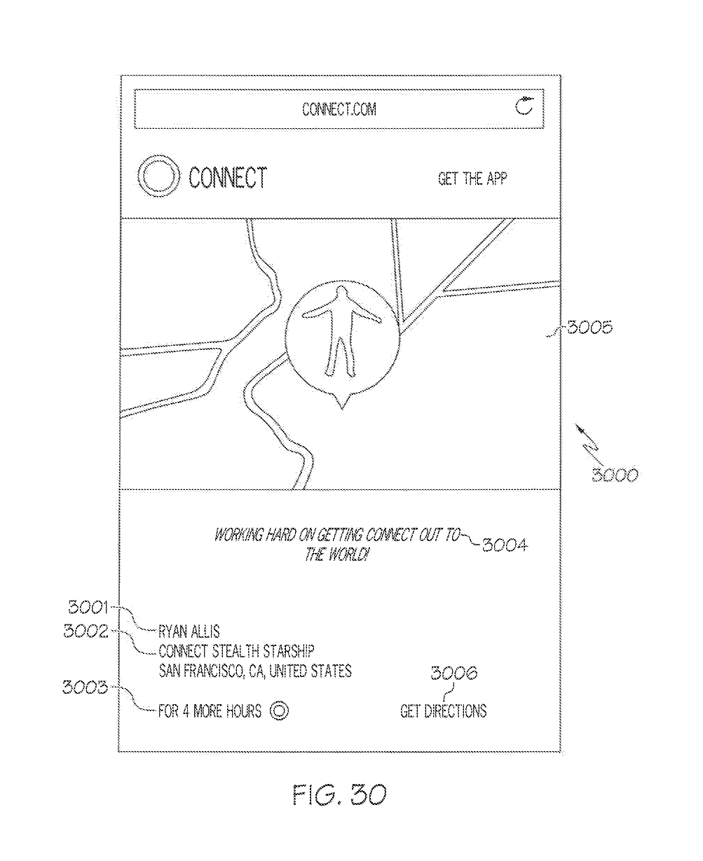

Some embodiments may provide the user with the ability to identify contacts intended to receive a user notification, establishing a level of privacy as opposed to broadcast user notifications. FIG. 28 is a further illustration of interface 2600 representing a selection of the option to make the post private via GUI control 2603, thereby limiting the contacts who would receive the transmission of the location-based user notification. In some embodiments, selecting GU control 2603 to the “Private post” position will transmit the posted user notification to a select group, a select contact, and/or a select push notification (e.g., SMS). In some embodiments, selecting GUI control 2603 to the “Private post” position will bring up an SMS user interface, similar to the user interface 2900 as illustrated in FIG. 29.

Some embodiments of user notification interfaces may enable SMS communication. FIG. 29 is a user interface 2900 that can be displayed within a user device 10 and that represents an SMS user interface 2900 for sending an SIMS text message 2902a including a hyperlink 2902b (e.g., link to a mobile web page that includes a status, location, map and directions to the user's location) to a contact 2901.

FIG. 30 is a user interface 3000 that can be displayed within a user device 10 and that represents the results of the hyperlink 2902b in FIG. 29, and includes the user's mobile web page 3000 within the Connect system 14, the user's name 3001, the user's location information 3002, the user's duration of time 3003 at the location identified, the user's status 3004, a map of the user's location 3005, and a link for directions 3006 to the user's location.

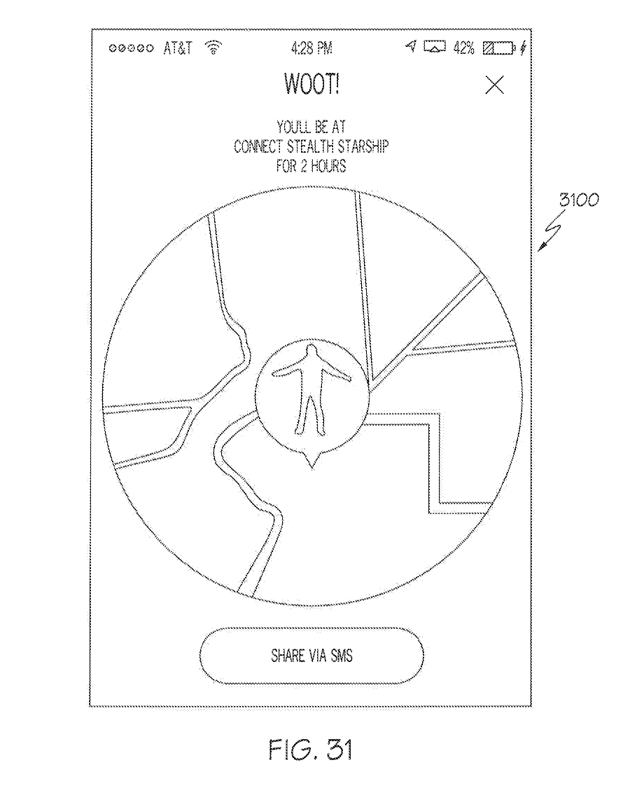

FIG. 31 is a user interface 3100 that can be displayed within a user device 10 and that represents a confirmation page of the user's transmission of location-based user notification including location information according to one or more embodiments disclosed herein.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

1. A method in a computer system for managing contact information relating to contacts of a user, the method comprising:
collecting contact information over a communications network from a plurality of identified sources, wherein the contact information includes location information;
transforming the collected contact information into a standardized format and eliminating duplicated information within the contact information;
resolving conflicting information within the contact information and consolidating collected contact information for a contact into a contact data record;
storing each contact data record in a data repository; and
wherein the collecting, transforming, eliminating, resolving, consolidating, and storing are performed on at least one computer processor.

2. The method of claim 1, wherein the collecting of contact information is responsive to receiving a user request to aggregate the contact information of the user from the plurality of identified sources.

3. The method of claim 1, wherein the contact information comprises at least one contact generated notification having contact location information about the contact.

4. The method of claim 1, further comprising:
storing a predefined notification parameter for use in filtering one or more contact notifications;
receiving a location-based contact notification from at least one of the plurality of identified sources, wherein the notification includes location information about a contact;
transforming the location information of the contact notification into a standardized format; and
wherein the storing, receiving, and transforming are performed on at least one computer processor.

5. The method of claim 4, wherein:
the predetermined notification parameter may be selected by a user using a user interface of a user device.

6. The method of claim 1, further comprising receiving a user notification for posting user information to at least one contact via at least one of the plurality of identified sources, converting the user notification into a source format, and posting the converted user notification to the at least one contact via the at least one of the plurality of identified sources.

7. The method of claim 6, wherein the at least one contact comprises a user selected group of contacts.

8. The method of claim 6, wherein the user notification includes user location information about the user.

9. The method of claim 8, wherein the user notification includes a length of time for display associated with the location information.

10. The method of claim 6, wherein the user information includes a limited communication.

11. The method of claim 1, further comprising:
periodically determining if contact information has changed at one or more of the plurality of identified sources;
updating one or more respective contact data records to reflect contact information changes; and
wherein the periodically determining if contact information has changed at one or more of the plurality of identified sources, and the updating one or more contact data records to reflect contact information changes are performed on the least one computer processor.

12. The method of claim 11, wherein the updating one or more respective contact data records to reflect contact information changes further comprises removing selected contact information from a data record so as to comply with terms of service of a source of the contact information.

13. The method of claim 4, wherein the method further comprises:
providing to the user interface of the user device a display of geographic map; and
displaying at least one marker on the map representative of a user contact, wherein each of the at least one marker indicates a location of the contact based on the location information of the contact, and comprises an image of the respective contact; and
wherein the providing of a display of a geographic map, and displaying at least one marker on the map are performed on the at least one processor.

14. The method of claim 1, wherein the standardized format for location information is by latitude and longitude.

15. The method of claim 1, wherein the resolving of conflicting information within the contact information is by assigning an empirically determined confidence factor to each of the conflicting information and selecting location information having a highest confidence factor.

16. The method of claim 1, wherein the resolving of conflicting information within the contact information is by assigning at least one dynamically determined confidence factor to the conflicting information and selecting location information having a highest confidence factor.

17. The method of claim 1, further comprising providing within each contact record a home location field, a work location field, and a current location field, and determining from the collected contact information of a contact any home location information, work location information, and current location information, and storing any home location information, work location information, and current location information within the respective fields in the respective contact record of the contact using the computer processor controlling the data repository.

18. A method in a computer system for managing contact information relating to contacts of a user, the method comprising:
collecting contact information over a communications network from a plurality of identified sources, wherein the contact information includes location information;
transforming the collected contact information into a standardized format and eliminating duplicated information within the contact information;
resolving conflicting information within the contact information and consolidating collected contact information for a contact into a contact data record;
storing each contact data record in a data repository;
storing a predefined notification parameter for use in filtering one or more contact notifications, the parameter selected by the user using a user interface of a user device;
receiving a location-based contact notification from at least one of the plurality of identified sources, wherein the notification includes location information about a contact, transforming the location information of the contact notification into a standardized format;
providing to the user interface of the user device a geographic map, displaying at least one marker on the map representative of the contact associated with the notification, wherein each of the at least one marker indicates a location of a contact based on the location information of that contact; and
wherein the collecting, transforming, eliminating, resolving, consolidating, storing of each contact data record and predefined notification parameter, and receiving are performed on at least one computer processor.

19. The method of claim 18, wherein the collecting of contact information is responsive to receiving a user request to aggregate the contact information of the user from the plurality of identified sources.

20. The method of claim 18, wherein the resolving of conflicting information within the contact information is by assigning an empirically determined confidence factor to each of the conflicting information and selecting location information having a highest confidence factor.

21. The method of claim 18, wherein the resolving of conflicting information within the contact information is by assigning at least one dynamically determined confidence factor to the conflicting information and selecting location information having a highest confidence factor.

22. The method of claim 18, further comprising receiving a user notification for posting user information to at least one contact via at least one of the plurality of sources, converting the user notification into a source format, and posting the user notification to the at least one contact via the at least one of the plurality of identified sources.

23. The method of claim 22, wherein the user notification includes location information about the user.

24. The method claim of claim 23, wherein the user notification includes a length of time for display associated with the location information.

25. A computer system for managing contact information relating to contacts of a user, the system comprising:
a processor, a memory coupled to the processor, the memory comprising computer readable program code embodied therein that, when executed by the processor, causes the processor to perform operations comprising:
collecting contact information over a communications network from a plurality of identified sources, wherein the contact information includes location information;
transforming the collected contact information into a standardized format and eliminating duplicated information within the contact information;
resolving conflicting information within the contact information and consolidating collected contact information for a contact into a contact data record;
storing each contact data record in a data repository;
storing a predefined notification parameter for use in filtering one or more contact notifications, the parameter selected by the user using a user interface of a user device;
receiving a location-based contact notification from at least one of the plurality of identified sources, wherein the notification includes location information about a contact, transforming the location information of the notification into a standardized format; and
providing a geographic map to the user interface of the user device, displaying at least one marker on the map representative of the contact associated with the contact notification, wherein each of the at least one marker indicates a location of a contact based on the location information of that contact.

26. The computer system of claim 25, wherein the collecting of contact information is responsive to receiving a user request to aggregate the contact information of the user from the plurality of identified sources.

27. The computer system of claim 25, wherein the resolving of conflicting information within the contact information is by assigning an empirically determined confidence factor to each of the conflicting information and selecting location information having a highest confidence factor.

28. The computer system of claim 25, wherein the resolving of conflicting information within the contact information is by assigning at least one dynamically determined confidence factor to the conflicting information and selecting location information having a highest confidence factor.

29. The computer system of claim 25, the operations further comprise receiving a user notification for posting user information to at least one contact via at least one of the plurality of sources, converting the user notification into a source format, and posting the user notification to the at least one contact via the at least one of the plurality of identified sources.

30. The computer system of claim 29, wherein the user notification includes location information about the user.

31. The computer system claim of claim 30, wherein the user notification includes a length of time for display associated with the location information.
